(19) United States
(12) Patent Application Publication
(10) Pub. No.: US 2010/0124656 A1
(43) Pub. Date: May 20, 2010

(54) OPTICAL SHEET AND METHOD FOR PRODUCING THE SAME

(75) Inventors: Tomoyuki HORIO, Tokyo-to (JP); Makoto HONDA, Tokyo-to (JP); Keiko TASAKI, Tokyo-to (JP); Takashi KURODA, Tokyo-to (JP); Emi SHIMANO, Tokyo-to (JP); Kana YAMAMOTO, Tokyo-to (JP)

Correspondence Address: LADAS & PARRY LLP, 224 SOUTH MICHIGAN AVENUE, SUITE 1600, CHICAGO, IL, 60604, US

(73) Assignee: DAI NIPPON PRINTING CO., LTD., Tokyo-to (JP)

(21) Appl. No.: 12/617,226

(22) Filed: Nov. 12, 2009

(30) Foreign Application Priority Data
Nov. 17, 2008 (JP) 2008-293929

(51) Int. Cl. B32B 5/16; C08F 2/48

(52) U.S. Cl. 428/331; 427/508; 977/773

(57) ABSTRACT

The present invention is to provide an optical sheet having excellent abrasion resistance and hardness, and a method for producing the same. The object of the present invention was accomplished by an optical sheet in which a hard coat layer is provided on one surface of a substrate, wherein the hard coat layer comprises a cured product of a curable resin composition for a hard coat layer, which composition comprising reactive, irregularly shaped silica fine particles and a binder component, and wherein at least part of the irregularly shaped silica fine particles have a specific three-dimensional configuration and are present on an interface on the side opposite to the substrate side of the hard coat layer. The object of the present invention was also accomplished by a method for producing the optical sheet, comprising the steps of: forming a coating by applying a curable resin composition for a hard coat layer comprising reactive, irregularly shaped silica fine particles and a binder component onto one surface of a substrate, and forming a hard coat layer by curing the coating with or after preventing that the long axes of the reactive, irregularly shaped silica fine particles are each oriented in a direction planar to a virtual plane.

### BACKGROUND OF THE INVENTION

1. Field of the Invention

The present invention relates to an optical sheet in which at least a hard coat layer is provided on a substrate, and which is used for protecting the surface of a display, etc. The present invention also relates to the method for producing the optical sheet.

2. Description of the Related Art

It has been required that the image display surface of an image display device such as a liquid crystal display, a CRT display, a projection display, a plasma display, an electroluminescence display and a reflection screen be imparted with abrasion resistance to avoid being scratched upon handling. To meet the request, in general, a hard coat (HC) sheet or optical sheet is used to increase the abrasion resistance of the image display surface of an image display device, which hard coat sheet comprising a hard coat layer provided on a substrate, and which optical sheet having optical functions such as anti-reflection properties or anti-glare properties.

A hard coat layer formed by curing a binder component only is likely to have insufficient abrasion resistance or hardness. Accordingly, as disclosed in Japanese Patent Application Laid-Open (JP-A) No. 2008-165040, it is common that inorganic fine particles such as silica fine particles are incorporated in the hard coat layer to increase the abrasion resistance or hardness of the layer.

In recent years, however, there is an increasing demand for optical sheets which have excellent abrasion resistance or hardness.

### SUMMARY OF THE INVENTION

The present invention was made to solve the above problem. An object of the present invention is to provide an optical sheet which has excellent abrasion resistance and hardness, and a method for producing the same.

The optical sheet of the present invention is an optical sheet in which a hard coat layer is adjacently provided on one surface of a substrate,

wherein the hard coat layer comprises a cured product of a curable resin composition for a hard coat layer, which composition comprising reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind;

wherein at least part of the reactive, irregularly shaped silica fine particles contained in the hard coat layer are cross-linked to the binder component; and

wherein at least part of the cross-linked, irregularly shaped silica fine particles present on an interface on the side opposite to the substrate side of the hard coat layer and in the vicinity of the interface, have a three-dimensional configuration in the hard coat layer, in which the long axes of the cross-linked, irregularly shaped silica fine particles are each oriented in a direction oblique or perpendicular to a virtual plane parallel to the hard coat layer, one end of each of which axes is present between said interface of the hard coat layer and the depth that is half the average primary particle diameter of the substantially spherical silica fine particles comprising the irregularly shaped silica fine particles, and the other end of each of which axes is present at the depth that is twice or more the average primary particle diameter of the substantially spherical silica fine particles comprising the irregularly shaped silica fine particles.

The reactive, irregularly shaped silica fine particles have high rigidity because each of the particles comprises said 3 to 20 substantially spherical silica fine particles which are connected to each other by firm and inorganic chemical bonding, thereby contributing to an increase in the abrasion resistance and hardness of the optical sheet.

In addition, as a result of having the above-mentioned three-dimensional configuration on the interface on the side opposite to the substrate side of the hard coat layer and in the vicinity of the interface, the cross-linked, irregularly shaped silica fine particles contribute to a further increase in the abrasion resistance and hardness of the interface of the hard coat layer and the vicinity of the interface.

In the optical sheet of the present invention, from the viewpoint of increasing the abrasion resistance and hardness of the optical sheet, the number of the irregularly shaped silica fine particles having said three-dimensional configuration and present in the interface on the side opposite to the substrate side of the hard coat layer is preferably three or more per 500 nm of length in a planar direction to the virtual plane.

In the optical sheet of the present invention, from the viewpoint of thinness, lightness, resistance to cracking and flexibility, the substrate is preferably an optically-transparent resin substrate.

In the optical sheet of the present invention, from the viewpoint of increasing the abrasion resistance and hardness of the optical sheet, the content rate of the reactive, irregularly shaped silica fine particles is preferably from 15 to 70 wt % with respect to the total solid content of the curable resin composition for a hard coat layer.

In a preferred embodiment of the optical sheet of the present invention, the hardness of the optical sheet can be 5H or more on the pencil hardness test defined in JIS K5600-5-4 (1999) with a load of 4.9 N.

The method for producing the optical sheet of the present invention comprises the steps of: preparing a curable resin composition for a hard coat layer, which composition comprising reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind;

forming a coating by applying the curable resin composition for a hard coat layer onto one surface of a substrate; and

forming a hard coat layer by curing the coating under light irradiation, with or after preventing that the long axes of the reactive, irregularly shaped silica fine particles are each oriented in a direction planar to a virtual plane parallel to the hard coat layer.

In the present invention, the “virtual plane parallel to the hard coat layer” means a plane which has, assuming that the hard coat layer is a layer having no fine concavoconvexes and being constant in thickness, a parallel positional relationship with the surface of the hard coat layer.

In the present invention, the average particle diameter of fine particles means the 50% particle diameter (d50 median diameter) of fine particles, which is obtained when fine particles in a solution are measured by dynamic light scattering and the particle size distribution thus obtained is expressed by a cumulative distribution. The average particle diameter may be measured by means of Microtrac particle size analyzer or Nanotrac particle size analyzer manufactured by Nikkiso Co., Ltd.

The “substantially spherical” as used herein means a shape that is close to a sphere (which may be a spheroid or polyhedral sphere), and it is a concept that also includes a perfect sphere.

In the present invention, the “hard coat layer” means a layer which can obtain a hardness of “H” or more on the pencil hardness test defined in JIS K5600-5-4 (1999) with a load of 4.9 N.

In the present invention, each of the reactive, irregularly shaped silica fine particles comprises said 3 to 20 silica fine particles being connected to each other by firm and inorganic chemical bonding; therefore, the optical sheet of the present invention is imparted with higher rigidity compared to the case where the silica fine particles are cross-linked to each other by an organic component, that is, reactive functional groups. In addition, the irregularly shaped silica fine particles cross-linked to the binder component has the above-mentioned three-dimensional configuration on the interface on the side opposite to the substrate side of the hard layer and in the vicinity of the interface, thereby contributing to a further increase in the abrasion resistance and hardness of the interface of the hard coat layer and the vicinity of the interface. In the method for producing the optical sheet according to the present invention, the reactive, irregularly shaped silica fine particles contained in the curable resin composition for a hard coat layer has a large aspect ratio (a value obtained by dividing the length of the long axis by that of the short axis), and a coating of the curable resin composition is cured with or after preventing that the long axes of the reactive, irregularly shaped silica fine particles having such a large aspect ratio are each oriented in a direction planar to the virtual plane. Therefore, it becomes easy for said cross-linked, irregularly shaped silica fine particles to form a three-dimensional configuration on the interface on the side opposite to the substrate side of the hard coat layer and in the vicinity of the interface, so that an optical sheet with excellent abrasion resistance and hardness can easily produced.

### BRIEF DESCRIPTION OF THE DRAWINGS

FIG. 1 is a sectional view schematically showing an example of cross-linking of silica fine particles on an interface on the side opposite to the substrate side of a conventional hard coat layer and in the vicinity of the interface.

FIG. 2 is a sectional view schematically showing an example of cross-linking of irregularly shaped silica fine particles on the interface on the side opposite to the substrate side of the hard coat layer of the optical sheet according to the present invention and in the vicinity of the interface.

FIG. 3 is a view schematically showing an example of the layer structure of the optical sheet according to the present invention.

FIG. 4 is a sectional view schematically showing an example of the distribution of the irregularly shaped silica fine particles on the interface on the side opposite to the substrate side of the hard coat layer of the optical sheet according to the present invention and in the vicinity of the interface.

FIG. 5 is a SEM photograph of a cross section of the optical sheet obtained in Example 1, which section showing the interface on the side opposite to the substrate side of the hard coat layer.

Reference numerals in the drawings are as follows:
10. Interface on the side opposite to the substrate side of the hard coat layer
20. Bulk part inside the hard coat layer
30, 31. Hard coat layer
40. Directions of cross-linking networks that can be formed
50. Cross-linked silica fine particles
60. Cross-linked, irregularly shaped silica fine particles
70. Substrate
80. Optical sheet
90. Virtual plane
100. Depth from the interface on the side opposite to the substrate side of the hard coat layer to half the average primary particle diameter of the silica fine particles
110. Depth from the interface on the side opposite to the substrate side of the hard coat layer to twice the average primary particle diameter of the silica fine particles

### DETAILED DESCRIPTION OF THE INVENTION

Hereinafter, the optical sheet of the present invention and the method for producing the same will be described in order.

In the present invention, “virtual plane parallel to a hard coat layer” means a plane which has, assuming that the hard coat layer is a layer having no fine concavoconvexes and being constant in thickness, a parallel positional relationship with the surface of the hard coat layer.

In the present invention, “(meth)acrylate” means acrylate and/or methacrylate.

In the present invention, “hard coat layer” means a layer which generally obtains a hardness of “H” or more on the pencil hardness test defined in JIS K5600-5-4 (1999) with a load of 4.9 N.

In the present invention, “light” includes not only electromagnetic waves having a wavelength in the visible or nonvisible region but also particle beams (e.g. electron beams) and radiation (a general term for electromagnetic waves and particle beams) or ionizing radiation.

In the present invention, “layer thickness” means the thickness of a dried layer (the dried layer thickness).

In the present invention, “molecular weight” means a polystyrene-equivalent weight average molecular weight measured by gel permeation chromatography (GPC) in the case where a compound has a molecular weight distribution. In the case where a compound has no molecular weight distribution, “molecular weight” means the molecular weight of the compound itself.

In the present invention, the average particle diameter of fine particles means the 50% particle diameter (d50 median diameter) of fine particles, which is obtained by measuring fine particles in a solution by dynamic light scattering and expressing the thus-obtained particle size distribution by a cumulative distribution. The average particle diameter may be measured by means of Microtrac particle size analyzer or Nanotrac particle size analyzer manufactured by Nikkiso Co., Ltd.

Hereinafter, the term “silica fine particles” (without saying “irregularly shaped silica fine particles”) means substantially spherical silica fine particles that have an average particle diameter from 1 to 100 nm and comprise irregularly shaped silica fine particles.

### I. Optical Sheet

The optical sheet of the present invention is an optical sheet in which a hard coat layer is adjacently provided on one surface of a substrate,

wherein the hard coat layer comprises a cured product of a curable resin composition for a hard coat layer, which composition comprising reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind;

wherein at least part of the reactive, irregularly shaped silica fine particles contained in the hard coat layer are cross-linked to the binder component; and

wherein at least part of the cross-linked, irregularly shaped silica fine particles present on an interface on the side opposite to the substrate side of the hard coat layer and in the vicinity of the interface, have a three-dimensional configuration in the hard coat layer, in which the long axes of the cross-linked, irregularly shaped silica fine particles are each oriented in a direction oblique or perpendicular to a virtual plane parallel to the hard coat layer, one end of each of which axes is present between said interface of the hard coat layer and the depth that is half the average primary particle diameter of the substantially spherical silica fine particles comprising the irregularly shaped silica fine particles, and the other end of each of which axes is present at the depth that is twice or more the average primary particle diameter of the substantially spherical silica fine particles comprising the irregularly shaped silica fine particles.

As a result of having the above-mentioned three-dimensional configuration on the interface on the side opposite to the substrate side of the hard coat layer and in the vicinity of the interface, the cross-linked, irregularly shaped silica fine particles contribute to a further increase in the abrasion resistance and hardness of the interface of the hard coat layer and the vicinity of the interface.

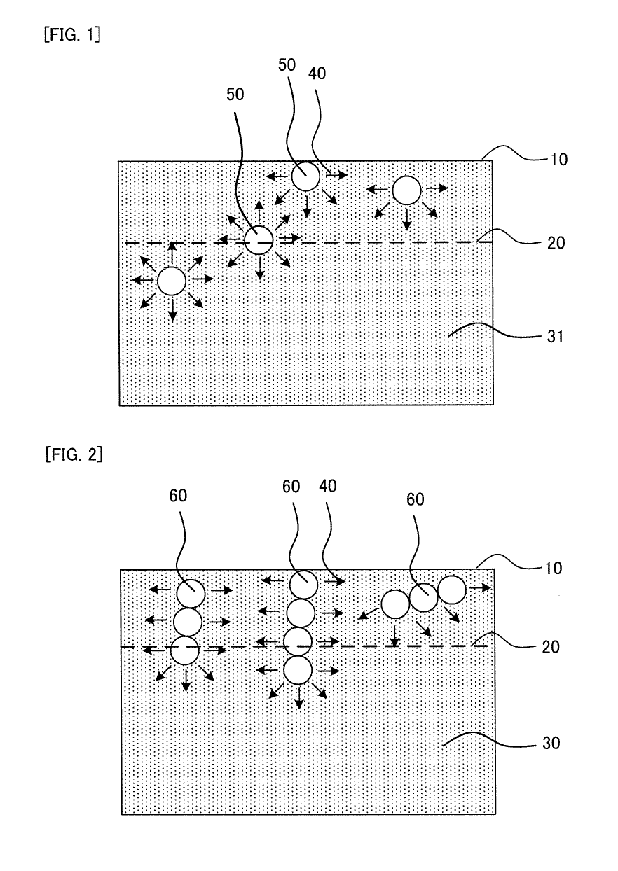

The reason of the contribution is not clear but can be considered as follows: as shown in FIG. 1, cross-linked silica fine particles 50 can form a 360-degree omnidirectional, that is, three-dimensional cross-linking network 40 in a non-interfacial part 20 inside a hard coat layer 31 (hereinafter, this part may be referred to as “bulk part”) which is formed by curing a composition containing conventional reactive silica fine particles only; however, on an interface 10 of the hard coat layer 31 and in the vicinity of the interface, the cross-linked silica fine particles 50 can form only a 180-degree (in the direction inside the layer 31), that is, two-dimensional, planar structure-like cross-linking network 40, so that the abrasion resistance and hardness of the interface 10 of the hard coat layer 31 and the vicinity of the interface are decreased compared to the part 20 inside the hard coat layer. In the present invention, however, as shown in FIG. 2, cross-linked, irregularly shaped silica fine particles 60 has the above-mentioned three-dimensional configuration in a hard coat layer 30 formed by curing a composition containing reactive, irregularly shaped silica fine particles as mentioned above, each of which particles comprising 3 to 20 silica fine particles connected to each other by firm and inorganic chemical bonding, so that the interface 10 of the hard coat layer 30 and the vicinity of the interface are connected with the bulk part 20 by the irregularly shaped silica fine particles which have higher rigidity than that of cross-links formed by reaction of an organic component, that is, reactive functional groups. This is presumed to be the reason that excellent abrasion resistance and hardness are imparted to the interface 10 of the hard coat layer 30 and the vicinity of the interface.

Because of the above reason, in the case where the cross-linked, irregularly shaped silica fine particles are not oriented in a direction that is oblique or perpendicular to the above-mentioned virtual plane, that is, in the case where the cross-linked irregularly shaped silica fine particles are oriented only in a planar direction (a direction parallel to the virtual plane), the interface of the hard coat layer and the vicinity of the interface cannot be connected with the bulk part inside the layer, thereby failing to obtain excellent abrasion resistance and hardness.

Even in the case where the cross-linked irregularly shaped silica fine particles are oriented in a direction that is oblique or perpendicular to the above-mentioned virtual plane, they cannot connect the interface of the hard coat layer and the vicinity of the interface with the bulk part inside the layer; therefore, fail to obtain excellent abrasion resistance and hardness when one end of each of their long axes is not present between the interface of the hard coat layer and the depth that is half the average primary particle diameter of the silica fine particles, or when the other end of each of their axes is present in a part on the interface side of the hard coat layer, which part is shallower than the depth that is twice the average primary particle diameter of the silica fine particles.

In a preferred embodiment of the optical sheet of the present invention, the hardness of the hard coat layer can be 5H or more on the pencil hardness test defined in JIS K5600-5-4 (1999) with a load of 4.9 N.

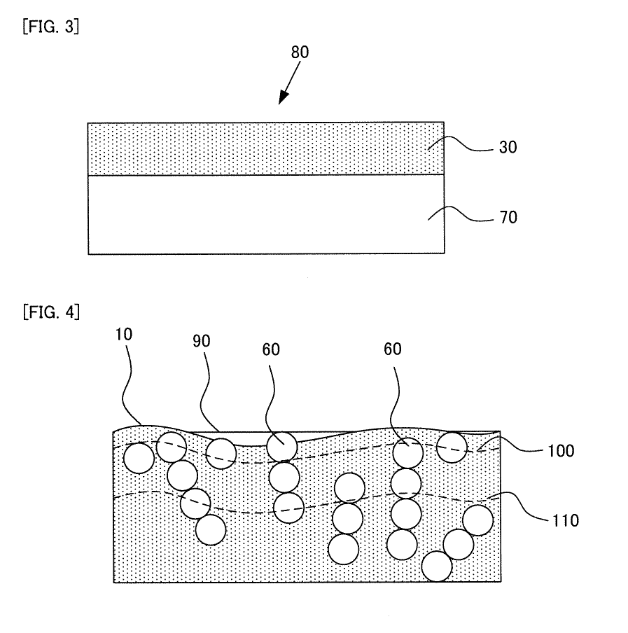

FIG. 3 is a view schematically showing an example of the layer structure of the optical sheet of the present invention.

In an optical sheet 80, the hard coat layer 30 is provided on one side of a substrate 70.

Hereinafter, essential components of the optical sheet of the present invention, a substrate and hard coat layer, and one or more kinds of layers which may be provided as needed and are selected from the group consisting of an anti-static layer, a low refractive index layer, an anti-fouling layer and a second hard coat layer that is the same as or different from said hard coat layer, will be described in order.

### 1. Substrate

The substrate used in the present invention may be appropriately selected based on the intended use of the optical sheet, and may be an optically-transparent or optically-nontransparent substrate. For example, an optically-nontransparent substrate may be used as the optical sheet used in a reflection screen or the like. As the optical sheet used for protecting the image display surface of a liquid crystal display, plasma display, organic EL display or the like, an optically-transparent substrate is preferred.

Examples of the optically-nontransparent substrate are as follows: for use in a reflection screen or in the white board of an electronic blackboard, for example, there may be mentioned a substrate having reflection diffusing properties, in which a coating layer is provided on one surface of a vinyl chloride film or the like, which layer comprising a white pigment; for use in a transmission-type screen, for example, there may be mentioned a substrate formed by imparting a lenticular lens shape on one surface of an optically-transparent substrate such as an acrylic substrate, followed by forming a pattern of black stripes with a light-absorbing ink on a non-light collecting part of the resulting lenticular lens on the other surface of the substrate; for use in a louver, for example, there may be mentioned a substrate having light-transparent parts and light-absorbing parts alternated thereon, which is formed by alternating thin layers of a transparent resin (such as polyethylene, polypropylene and acrylic) mixed with a light-absorbing pigment and thin layers of a transparent resin (such as polyethylene, polypropylene and acrylic) on the substrate, and slicing the layered substrate in a direction perpendicular to the surface of the resulting transparent and light-absorbing thin layers; for use in a touch-sensitive panel, for example, there may be mentioned a substrate in which a light-absorbing and light-blocking frame is printed on the periphery of an image displaying part of a polyester film, and a substrate patterned with an icon frame or design.

The optically-transparent substrate may be transparent, semi-transparent, colorless or colored as long as light can pass through the substrate. Preferably, in the visible light region from 380 to 780 nm, the substrate has an average light transmittance of 50% or more, preferably 70% or more, more preferably 85% or more. Light transmittance is measured by means of an ultraviolet-visible spectrophotometer (such as UV-3100PC manufactured by Shimadzu Corporation) and using values obtained at room temperature in the air.

In the present invention, the thickness of the substrate may be appropriately selected based on the intended use. The concept of the substrate includes films and sheets, and the material of the substrate may be resin or glass.

Optically-transparent resin substrates are excellent in thinness, lightness, hardness and flexibility.

As the optical sheet used for protection of the image display surface, especially, it is preferable to use an optically-transparent resin substrate having a thickness from 20 to 120 μm, more preferably from 20 to 80 μm, from the viewpoint of making the surface of the optical sheet difficult to break and imparting hardness thereto.

Preferred as the material of the optically-transparent resin substrate is, for example, a material mainly comprising cellulose acylate, cycloolefin polymers, polycarbonates, acrylate-based polymers or polyester. The “mainly comprising” used here means a component that has the highest content rate among the components of the substrate.

Specific examples of cellulose acylate include cellulose triacetate, cellulose diacetate and cellulose acetate butyrate.

Examples of cycloolefin polymers include norbornene polymers, monocyclic olefin polymers, cyclic conjugated diene polymers and vinyl alicyclic hydrocarbon polymer resins. More specifically, there may be ZEONEX and ZEONOR (norbornene resin) manufactured by ZEON CORPORATION, SUMILITE FS 1700 manufactured by SUMITOMO BAKELITE CO., LTD., ARTON (modified norbornene resin) manufactured by JSR Corporation, APEL (cycloolefin copolymer) manufactured by MITSUI CHEMICALS, INC., Topas (cycloolefin copolymer) manufactured by Ticona, and OZ 1000 Series of OPTOREZ (alicyclic acrylic resin) manufactured by Hitachi Chemical Company, Ltd.

Specific examples of polycarbonates include aromatic polycarbonates based on bisphenols (such as bisphenol A) and aliphatic polycarbonates such as diethylene glycol bis(allylcarbonate).

Specific examples of acrylate-based polymers include poly(methyl (meth)acrylate), poly(ethyl(meth)acrylate) and a methyl(meth)acrylate-butyl(meth)acrylate copolymer.

Specific examples of polyester include polyethylene terephthalate and polyethylene naphthalate.

A material which may be used as the optically-transparent resin substrate used in the present invention and which is most excellent in optical transparency is cellulose acylate. Especially, triacetyl cellulose is preferably used.

Triacetyl cellulose (TAC) films are an optically-transparent substrate which is able to have an average light transmittance of 50% or more in the visible light region from 380 to 780 nm. When used in the present invention, the average light transmittance of a TAC film is preferably 70% or more, more preferably 85% or more.

Because of having optical isotropy, TAC films may be suitably used also in liquid crystal display applications.

As the triacetyl cellulose used in the present invention, besides pure triacetyl cellulose, there may be used one containing a cellulose ester such as cellulose acetate propionate and cellulose acetate butylate. As needed, the triacetyl cellulose may be mixed with other cellulose lower fatty acid ester such as diacetyl cellulose, or various kinds of additives such as a plasticizer, an anti-static agent and a UV absorbing agent.

Also in the present invention, a surface treatment (such as a saponification treatment, a glow discharge treatment, a corona discharge treatment, an ultraviolet (UV) treatment and a flame treatment) may be performed on the substrate. A primer layer (adhesive layer) may be formed thereon. The optically-transparent resin substrate in the present invention may be subjected to a surface treatment or have a primer layer formed thereon.

### 2. Hard Coat Layer

The hard coat layer of the present invention comprises a cured product of a curable resin composition for a hard coat layer, which composition comprising reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind; wherein at least part of the reactive, irregularly shaped silica fine particles contained in the hard coat layer are cross-linked to the binder component; and wherein at least part of the cross-linked, irregularly shaped silica fine particles present on an interface on the side opposite to the substrate side of the hard coat layer and in the vicinity of the interface, have a three-dimensional configuration in the hard coat layer, in which the long axes of the cross-linked, irregularly shaped silica fine particles are each oriented in a direction oblique or perpendicular to a virtual plane parallel to the hard coat layer, one end of each of which axes is present between said interface of the hard coat layer and the depth that is half the average primary particle diameter of the substantially spherical silica fine particles comprising the irregularly shaped silica fine particles, and the other end of each of which axes is present at the depth that is twice or more the average primary particle diameter of the substantially spherical silica fine particles comprising the irregularly shaped silica fine particles.

The reactive, irregularly shaped silica fine particles have excellent strength because each of the particles comprises said 3 to 20 substantially spherical silica fine particles being connected to each other by firm and inorganic chemical bonding. Hence, the reactive, irregularly shaped silica fine particles contribute to an increase in the abrasion resistance and hardness of the optical sheet.

In addition, as a result of having the above-mentioned three-dimensional configuration on the interface on the side opposite to the substrate side of the hard coat layer and in the vicinity of the interface, the cross-linked, irregularly shaped silica fine particles contribute to a further increase in the abrasion resistance and hardness of the interface of the hard coat layer and the vicinity of the interface.

In the case where the cross-linked, irregularly shaped silica fine particles are not oriented in a direction that is oblique or perpendicular to the above-mentioned virtual plane, that is, in the case where the cross-linked irregularly shaped silica fine particles are oriented only in a planar direction (a direction parallel to the virtual plane), the interface of the hard coat layer and the vicinity of the interface cannot be connected with the bulk part inside the layer, thereby failing to obtain excellent abrasion resistance and hardness.

Even in the case where the cross-linked irregularly shaped silica fine particles are oriented in a direction that is oblique or perpendicular to the above-mentioned virtual plane, they cannot connect the interface of the hard coat layer and the vicinity of the interface with the bulk part inside the layer; therefore, they fail to obtain excellent abrasion resistance and hardness when one end of each of their long axes is not present between the interface of the hard coat layer and the depth that is half the average primary particle diameter of the silica fine particles, or when the other end of each of their axes is present in a part on the interface side of the hard coat layer, which part is shallower than the depth that is twice the average primary particle diameter of the silica fine particles.

One end of each of the axes is only needed to be present between the interface on the side opposite to the substrate side of the hard coat layer and the depth that is half the average primary particle diameter of the substantially spherical silica fine particles, and may be protruded from the interface of the hard coat layer.

The other end of each of the axes is present at the depth that is twice or more the average primary particle diameter of the substantially spherical silica fine particles. Because of this, the part where one end of each of the axes is present can be firmly connected by the irregularly shaped silica fine particles with the part where the other end of each of the axes is present.

FIG. 4 is a sectional view schematically showing an example of the interface on the side opposite to the substrate side of the hard coat layer of the present invention and the vicinity of the interface.

The long axes of the irregularly shaped silica fine particles 60 are each oriented in a direction oblique or perpendicular to a virtual plane 90 that is parallel to the hard coat layer, which particles being cross-linked to the binder component and/or other reactive, irregularly shaped silica fine particles. One end of the cross-linked, irregularly shaped silica fine particles 60 is present between the interface 10 of the hard coat layer and a depth 100 that is half the average primary particle diameter of the substantially spherical silica fine particles. The other end of each of the long axes of the cross-linked, irregularly shaped silica fine particles 60 is present at the position which is deeper than a depth 110 that is twice the average primary particle diameter of the substantially spherical silica fine particles.

From the viewpoint of increasing the abrasion resistance and hardness of the hard coat layer, the number of the irregularly shaped silica fine particles having said three-dimensional configuration and present in the interface on the side opposite to the substrate side of the hard coat layer is preferably three or more per 500 nm of length in a planar direction to the virtual plane. The upper limit of the number of the irregularly shaped silica fine particles per 500 nm of length is only needed to be appropriately adjusted based on the average primary particle diameter of the substantially-spherical silica fine particles, the aspect ratio of the irregularly shaped silica fine particles, and performances that are required for the optical sheet such as hardness and optical transparency. For example, in the case of irregularly shaped silica fine particles which has an aspect ratio from 3 to 20 and comprise substantially-spherical silica fine particles having an average primary particle diameter from 12 to 50 nm, the number of the irregularly shaped silica fine particles per 500 nm of length is preferably less than 20, more preferably less than 10. If the content of the reactive, irregularly shaped silica fine particles in the curable resin composition for a hard coat layer is increased to increase the number to 20 or more, the particles may be likely to drop off from the hard layer due to binder shortage. If rapid drying is carried out to control the orientation of the particles, a dry spot may occur, which may cause a defect.

The layer thickness of the hard coat layer is only needed to be adjusted based on the performances required for the optical sheet, and it is preferably from 3 to 25 μm, more preferably from 5 to 20 μm. If more than 3 μm, sufficient strength can be easily obtained. To retain the hardness of the hard coat layer with preventing a decrease in the adhesion of the same and occurrence of fringes, the thickness of the hard coat layer is preferably 10 μm or more, more preferably 15 μm or more. A thickness of more than 25 μm may result in a cost increase. In the case of using a film having a thin substrate, such as a triacetyl cellulose film having a thickness of 100 μm or less, curling or cracking is likely to occur when the layer thickness of the hard coat layer exceeds 25 μm. In addition, for example, when the layer thickness of the hard coat layer exceeds 25 μm, it is difficult for a solvent (such as an organic solvent and water) that is used in an adhesive for attaching the optical sheet of the present invention to a polarizer to vaporize at the time of attaching them, and drying efficiency may be significantly deteriorated, therefore. If the solvent used in the adhesive stays in the adhesive, a change in the polarization degree of the polarizer may occur, which may lead to a decrease in the performance of the polarizer.

Hereinafter, a curable resin composition for a hard coat layer will be described, which is cured to form the hard coat layer of the present invention.

### (Curable Resin Composition for a Hard Coat Layer)

The curable resin composition for a hard coat layer of the present invention comprises reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind.

In addition, the curable resin composition for a hard coat layer may contain, for example, an anti-glare agent, anti-fouling agent and/or anti-static agent for the purpose of imparting functionalities, a leveling agent or solvent for the purpose of controlling coatability, and a smoothing agent for the purpose of prevention of blocking.

### (Reactive, Irregularly Shaped Silica Fine Particles)

The reactive, irregularly shaped silica fine particles is a component that contributes to an increase in the hardness of the hard coat layer after curing, because they have reactive functional groups a on the surface thereof, and each of which particles comprises 3 to 20 substantially spherical silica fine particles having an average primary particle diameter from 1 to 100 nm and being connected to each other by inorganic chemical bonding.

By incorporating the reactive, irregularly shaped silica fine particles in the curable resin composition for a hard coat layer, the reactive, irregularly shaped silica fine particles are allowed to be cross-linked to each other. Because the reactive, irregularly shaped silica fine particles are cross-linked to the binder component which will be described below, it becomes possible to increase the hardness and abrasion resistance of the hard coat layer.

The irregularly shaped silica fine particles of the present invention have excellent rigidity because they are connected to each other by inorganic chemical bonding, unlike conventional, reactive, substantially-spherical silica fine particles which are connected to each other via a binder component thanks to reactive functional groups a. The optical sheet of the present invention is imparted with excellent abrasion resistance and hardness by performing a surface treatment on the irregularly shaped silica fine particles and using the resulting reactive, irregularly shaped silica fine particles having reactive functional groups a on the surface thereof.

At least part of the cross-linked, irregularly shaped silica fine particles present on the interface on the side opposite to the substrate side of the hard coat layer and in the vicinity of the interface, have a three-dimensional configuration in the hard coat layer, in which the long axes of the cross-linked, irregularly shaped silica fine particles are each oriented in a direction oblique or perpendicular to a virtual plane parallel to the hard coat layer, one end of each of which axes is present between said interface of the hard coat layer and the depth that is half the average primary particle diameter of the substantially spherical silica fine particles comprising the irregularly shaped silica fine particles, and the other end of each of which axes is present at the depth that is twice or more the average primary particle diameter of the substantially spherical silica fine particles comprising the irregularly shaped silica fine particles. Because of this, the irregularly shaped silica fine particles which have high rigidity attributed to inorganic chemical bonding, not cross-linking between the reactive functional groups which are an organic component, connect the interface and the vicinity of the interface with the bulk part inside the hard coat layer, thereby imparting excellent abrasion resistance and hardness to the optical sheet of the present invention.

In the case of a substrate having a low refractive index (e.g., a resin substrate comprising a resin such as triacetyl cellulose), because the refractive index of the silica fine particles is about 1.46 and lower than the refractive index of the binder component of about 1.50, lowering the refractive index of the hard coat layer creates an effect in which there is a decrease in the difference between the refractive index of the hard coat layer and that of the resin substrate, thereby preventing occurrence of fringes. Also, by orienting the long axes of the irregularly shaped silica fine particles each in a direction oblique or perpendicular to a virtual plane on the interface between the hard coat layer and the substrate, if the substrate is penetrable with a solvent or monomer contained in the curable resin composition for a hard coat layer, a large load is applied on the area of the substrate on which a force, which is generated by polymerization shrinkage of the hard coat layer and is smaller than the case of orienting the long axes each in a direction planar to the virtual plane, is applied. Accordingly, fine concavoconvexes are formed on the interface on the hard coat layer side of the substrate. Because of this, the border of the refractive indices of the substrate and hard coat layer becomes unclear, so that the difference between the refractive indices is decreased, and the effect of prevention of occurrence of fringes is thus increased.

The average primary particle diameter of the silica fine particles comprising the irregularly shaped silica fine particles by inorganic chemical bonding is from 1 to 100 nm, preferably from 10 to 80 nm, more preferably from 12 to 50 nm. If the average primary particle diameter of the silica fine particles is less than 1 nm, they cannot contribute to an increase in the abrasion resistance and hardness of the hard coat layer. If the average primary particle diameter exceeds 100 nm, there is an increase in the haze of the hard coat layer.

In the curable resin composition for a hard coat layer, the average primary particle diameter of the silica fine particles may be measured by the above-mentioned dynamic light scattering. Alternatively, in the cured hard coat layer, the average primary particle diameter may be an average of the lengths of the long and short axes measured by the following method: a SEM or TEM photograph of a cross section of the hard coat layer is taken to observe silica fine particles; among the observed silica fine particles, 100 particles are selected and measured for the lengths of their long axes and short axes; finally, the thus-obtained lengths are averaged to obtain the average primary particle diameter of the silica fine particles.

The silica fine particles may be particles having a single average primary particle diameter or a combination of two or more kinds of particles having different average primary particle diameters. In the case of a combination of two or more kinds of particles, the average primary particle diameter of each kind is needed to be within 1 to 100 nm.

In the hard coat layer, the size of the reactive, irregularly shaped silica fine particles is obtained as follows: a SEM or TEM photograph of a cross section of the hard coat layer is taken to observe cured silica fine particles; from the observed particles, 100 particles are selected; among the selected 100 particles, those having an aspect ratio of less than 1.3 are observed to measure the average particle diameter, which is referred to as the average primary particle diameter; 5 lengths are selected from the lengths of the long axes of the selected 100 particles, which 5 lengths having their aspect ratios in the vicinity of the maximum aspect ratio, and the average of these 5 lengths is obtained, which is referred to as the length of the long axis.

Each of the irregularly shaped silica fine particles of the present invention comprises 3 to 20 of the silica fine particles, preferably 3 to 10 of the silica fine particles, which are connected to each other by inorganic chemical bonding.

When the number of the silica fine particles connected to each other by inorganic chemical bonding is three or more, an effect of increasing the abrasion resistance and hardness of the hard coat layer can be obtained. If the number of the silica fine particles connected to each other by inorganic chemical bonding is more than 20, the optical transparency of the hard coat layer decreases, resulting in a deterioration in the transmittance and an increase in the haze.

The size of the reactive, irregularly shaped silica fine particles (that is, the length of the long axis of the reactive, irregularly shaped silica fine particles) each of which comprising 3 to 20 of the silica fine particles and which 3 to 20 silica fine particles being connected to each other by inorganic chemical bonding, is not particularly limited and is preferably from 20 to 300 nm. If the size is in this range, it is easy to impart abrasion resistance and hardness to the hard coat layer and also to retain the optical transparency of the hard coat layer.

The aspect ratio of the irregularly shaped silica fine particles, each of which comprising 3 to 20 of the silica fine particles and each of which 3 to 20 silica fine particles being connected to each other by inorganic chemical bonding, is preferably from 3 to 20, so that the ratio of the other ends of the long axes is increased, which ends are present in the bulk part inside the layer, and the abrasion resistance and hardness of the optical sheet can be easily increased, therefore.

As the inorganic chemical bonding, for example, there may be mentioned ionic bonding, metal bonding, coordination bonding and covalent bonding. Preferred is bonding which does not disperse the connected silica fine particles after the irregularly shaped silica fine particles are added to a polar solvent, such as metal bonding, coordination bonding and covalent bonding in particular, and covalent bonding is more preferred. Conventional aggregates with no covalent bonding may be broken by a physical external force (for example, in the state of ink, by a shearing force applied upon stirring or coating using a doctor knife, etc.) From a chemical standpoint, aggregates with no covalent bonding may be broken by an additive such as a solvent which is able to break aggregates, a binder component, and a surfactant. Aggregates with no covalent bonding are not preferred because, even after forming an optical sheet, they are broken by physical external force (such as contact with a sharp object or the like), which may be a scratch of the optical sheet. In contrast, covalent bonding is less likely to cause decomposition by a physical or chemical force and is stable.

As the polar solvent, for example, there may be mentioned water and lower alcohol such as methanol, ethanol and isopropanol.

The present invention does not exclude the use of particles having voids or a porous structure inside the particles, such as hollow particles. From the viewpoint of increasing the hardness of the hard coat layer, however, it is preferable to use solid particles having no voids or porous structure inside the particles.

Preferably, the silica fine particles have a sharp particle size distribution and are monodisperse from the viewpoint of increasing the hardness of the hard coat layer without deteriorating the optical transparency of the same and with keeping a recovery rate in the case of using a binder component only, which will be described below.

The content rate of the reactive, irregularly shaped silica fine particles may be appropriately adjusted based the physical properties required for the optical sheet, and is preferably is from 15 to 70 wt %, more preferably from 35 to 65 wt %, still more preferably from 50 to 65 wt %, with respect to the total solid content of the curable resin composition for a hard coat layer. If the content rate is less than 15 wt %, sufficient hardness may not be imparted to the hard coat layer. When the irregularly shaped silica fine particles are close-packed, the content of the same with respect to the curable resin composition for a hard coat layer is 70 wt %. Consequently, if the content exceeds 70 wt %, the filling rate of the reactive, irregularly shaped silica fine particles is excessively increased, so that the adhesion between the irregularly shaped silica fine particles and the binder component is deteriorated, which may decrease the hardness of the hard coat layer, on the contrary. If the content of the reactive, irregularly shaped silica fine particles is 50 wt % or more, the rate of the same in the coating is high; moreover, the reactive, irregularly shaped silica fine particles are densely present on the substrate side of the coating, and the region (thin resin layer) which is present on the interface on the side opposite to the substrate side of the coating and which, in many cases, comprises a binder component only and contains no said particles is further decreased, so that the rotation of the reactive, irregularly shaped silica fine particles that are present on the interface on the side opposite to the substrate side of the coating and in the vicinity of the interface, is presumed to be limited more certainly. Therefore, it becomes easy for the irregularly shaped silica fine particles, to form the three-dimensional configuration on the interface on the side opposite to the substrate side of the hard coat layer.

Normally, the surface of the silica fine particles has groups that cannot be present inside the silica fine particles as they are. In general, these groups on the surface are functional groups that are relatively reactive. For example, they are hydroxyl groups or oxy groups in the case of metal oxides. In the case of metal sulfides, they are thiol groups or thio groups, for instance. In the case of nitrides, they are amino groups, amide groups or imide groups, for instance.

The reactive, irregularly shaped silica fine particles may be those that are able to impart an additional function(s) to the hard coat layer, and they are appropriately selected for use depending on the intended purpose.

Reactive functional groups a that are introduced onto the surface of the irregularly shaped silica fine particles so that the reactive, irregularly shaped silica fine particles can react with a binder component that will be described below, are appropriately selected depending on the binder component. As the reactive functional groups a, polymerizable unsaturated groups are suitably used. Preferred are photocurable unsaturated groups, and particularly preferred are ionizing radiation-curable unsaturated groups. Specific examples thereof include an ethylene double bond such as a (meth)acryloyl group, a vinyl group and an allyl group, and an epoxy group.

The reactive functional groups a of the reactive, irregularly shaped silica fine particle may be the same as or different from reactive functional groups b of the binder component.

The reactive, irregularly shaped silica fine particles are such that at least part of the particle surface is covered with an organic component, and each particle has the reactive functional groups a introduced onto the surface covered with the organic component. The “organic component” used here refers to a component containing a carbon. Embodiments in which at least part of the particle surface is covered with an organic component include, for example, an embodiment in which a compound containing an organic component such as a silane coupling agent reacts with hydroxyl groups present on the surface of the irregularly shaped silica fine particles, thereby binding the organic component to part of the particle surface; an embodiment in which a compound containing an organic component having isocyanate groups reacts with hydroxyl groups present on the surface of the irregularly shaped silica fine particles; and an embodiment in which an organic component is attached to hydroxyl groups present on the surface of the irregularly shaped silica fine particles by interaction such as hydrogen bonding; and an embodiment in which one or more of the irregularly shaped silica fine particles are contained in each polymer particle.

As the method of preparing the reactive, irregularly shaped silica fine particles in which at least part of the particle surface is covered with an organic component and each particle has the reactive functional groups a introduced onto the surface covered with the organic component, a conventionally-known method may be appropriately selected for use depending on the reactive functional groups a that are required to be introduced onto the irregularly shaped silica fine particles.

Especially in the present invention, it is preferred to appropriately select any of the following irregularly shaped silica fine particles (i) and (ii) for use, from the viewpoint of preventing aggregation of the irregularly shaped silica fine particles and increasing the hardness of a film:

(i) irregularly shaped silica fine particles having reactive functional groups a on the surface thereof, which particles are obtained by dispersing irregularly shaped silica fine particles in water and/or an organic solvent serving as a dispersion medium, in the presence of one or more kinds of surface modification compounds which have a molecular weight of 500 or more and are selected from the group consisting of a saturated or unsaturated carboxylic acid, an acid anhydride, acid chloride, ester and acid amide corresponding to the carboxylic acid, an amino acid, an imine, a nitrile, an isonitrile, an epoxy compound, an amine, a β-dicarbonyl compound, silane and a metallic compound having a functional group;

(ii) irregularly shaped silica fine particles having reactive functional groups a on the surface thereof, which particles are obtained by bonding irregularly shaped silica fine particles to a compound containing reactive functional groups a that will be introduced onto the irregularly shaped silica fine particles to be covered, a group represented by the following chemical formula (1), and a silanol group or a group that is able to become a silanol group by hydrolysis:

-Q¹-C(=Q²)-Q³- Chemical Formula (1)

wherein Q¹ is NH, O (oxygen atom) or S (sulfur atom); Q² is O or S; and Q³ is NH or a divalent organic group.

Hereinafter, the reactive, irregularly shaped silica fine particles which are suitably used in the present invention will be described in order.

(i) Irregularly shaped silica fine particles having reactive functional groups a on the surface thereof, which particles are obtained by dispersing irregularly shaped silica fine particles in water and/or an organic solvent serving as a dispersion medium, in the presence of one or more kinds of surface modification compounds which have a molecular weight of 500 or more and are selected from the group consisting of a saturated or unsaturated carboxylic acid, an acid anhydride, acid chloride, ester and acid amide corresponding to the carboxylic acid, an amino acid, an imine, a nitrile, an isonitrile, an epoxy compound, an amine, a 3-dicarbonyl compound, silane and a metallic compound having a functional group.

Use of the reactive, irregularly shaped silica fine particles (i) is advantageous in that the film strength can be increased even if the content of the organic component is small.

The surface modification compound used for the reactive, irregularly shaped silica fine particles (i) has functional groups that can chemically bind to, upon dispersion, groups that are present on the surface of the irregularly shaped silica fine particles, such as a carboxyl group, an acid anhydride group, an acid chloride group, an acid amide group, an ester group, an imino group, a nitrile group, an isonitrile group, a hydroxyl group, a thiol group, an epoxy group, a primary, secondary or tertiary amino group, a Si—OH group, a hydrolyzable residue of silane, or a C—H acid group such as a β-dicarbonyl compound. The chemical bonding here preferably includes covalent bonding, ionic bonding or coordination bonding, and hydrogen bonding. Coordination bonding is considered to be complex forming. For example, an acid-base reaction according to the Brønsted or Lewis definition, complex formation or esterification occurs between the functional groups of the surface modification compound and the groups present on the surface of the irregularly shaped silica fine particles. The surface modification compound used for the reactive, irregularly shaped silica fine particles (i) may be one kind of component solely or a mixture of two or more kinds of components.

In addition to at least one functional group (hereinafter referred to as first functional group) that can participate in chemical bonding with the groups that are present on the surface of the irregularly shaped silica fine particles, the surface modification compound normally has molecular residues that impart, after the surface modification compound is combined, a new property to the irregularly shaped silica fine particles via the functional group. The molecular residues or part of the molecular residues are hydrophobic or hydrophilic and, for example, can stabilize, compatibilize or activate the irregularly shaped silica fine particles.

As the hydrophobic molecular residue, for example, there may be mentioned an alkyl, aryl, alkaryl, aralkyl or fluorine-containing alkyl group, all of which induce inactivation or repulsion. As the hydrophilic group, for example, there may be mentioned a hydroxy group, alkoxy group or polyester group.

In the case where the reactive functional groups a which are reactive with a binder component that will be described below are contained in the molecular residues of the surface modification compound, the reactive functional groups a that are reactive with the binder component can be introduced onto the surface of the irregularly shaped silica fine particles (i) by allowing the first functional group contained in the surface modification compound to react with the surface of the irregularly shaped silica fine particles. For example, as a suitable one, there may be mentioned a surface modification compound having a polymerizable unsaturated group besides the first functional group.

Meanwhile, by allowing a second reactive functional group to be contained in the molecular residues of the surface modification compound and by the aid of the second reactive functional groups, the reactive functional groups a that are reactive with the binder component may be introduced onto the surface of the reactive, irregularly shaped silica fine particles (i). For example, it is preferable to introduce the reactive functional groups a that are reactive with the binder component in such a manner that groups capable of hydrogen bonding (hydrogen bond-forming groups) such as a hydroxyl group and an oxy group are introduced as the second reactive functional groups so that the hydrogen bond-forming groups are introduced onto the surface of the inorganic fine particles and further react with hydrogen bond-forming groups of a different surface modification compound. That is, as a suitable example, there may be mentioned use of a compound having a hydrogen bond-forming group in combination with the reactive functional group a that is reactive with the binder component (such as polymerizable unsaturated groups) as the surface modification compound. Specific examples of the hydrogen bond-forming groups include functional groups such as a hydroxyl group, a carboxyl group, an epoxy group, a glycidyl group and an amide group, or one capable of having an amide bond. The amide bond here refers to one containing —NHC(O) or >>NC(O)— in the binding unit thereof. As the hydrogen bond-forming group used in the surface modification compound of the present invention, a carboxyl group, hydroxyl group or amide group is particularly preferred.

The surface modification compound used for preparation of the reactive, irregularly shaped silica fine particles (i) preferably has a molecular weight of 500 or less, more preferably 400 or less, particularly preferably 200 or less. Because of having such a low molecular weight, the surface modification compound is presumed to be able to rapidly cover the surface of the irregularly shaped silica fine particles, so that the covered irregularly shaped silica fine particles are prevented from aggregation.

The surface modification compound used for preparation of the reactive, irregularly shaped silica fine particles (i) is preferably liquid in the reaction condition for surface modification, and it is preferable that the compound is soluble or at least can be emulsified in a dispersion medium. Especially, it is preferable that the surface modification compound can be dissolved in a dispersion medium to exist as molecules or molecular ions dispersed uniformly in the dispersion medium.

The saturated or unsaturated carboxylic acid has 1 to 24 carbon atoms. Examples thereof include formic acid, acetic acid, propionic acid, butyric acid, valeric acid, caproic acid, acrylic acid, methacrylic acid, crotonic acid, citric acid, adipic acid, succinic acid, glutaric acid, oxalic acid, maleic acid, fumaric acid, itaconic acid and stearic acid, as well as the corresponding acid anhydrides, chlorides, esters and amides, such as caprolactam. Further, it is possible to introduce polymerizable unsaturated groups by using an unsaturated carboxylic acid.

An example of preferred amine is one having the chemical formula Q₃₋ₙNHₙ (n=0, 1 or 2), wherein the residue Q independently represents an alkyl (such as methyl, ethyl, n-propyl, i-propyl and butyl) having 1 to 12 carbon atoms, more preferably 1 to 6 carbon atoms, particularly preferably 1 to 4 carbon atoms, and an aryl, alkaryl or aralkyl (such as phenyl, naphthyl, tolyl and benzyl) having 6 to 24 carbon atoms. Also, an example of preferred amine is polyalkyleneamine. Specific examples thereof include methylamine, dimethylamine, trimethylamine, ethylamine, aniline, N-methylaniline, diphenylamine, triphenylamine, toluidine, ethylenediamine and diethylenetriamine.

The β-dicarbonyl compound is preferably one having 4 to 12 carbon atoms, particularly preferably 5 to 8 carbon atoms, such as diketone (acetylacetone, etc.), 2,3-hexanedione, 3,5-heptanedione, acetoacetic acid, acetoacetic acid-C₁-C₄-alkyl ester (acetoacetic acid ethyl ester, etc.), diacetyl and acetonylacetone.

Examples of the amino acid include β-alanine, glycine, valine, amino caproic acid, leucine and isoleucine.

Preferred silane is hydrolyzable organosilane having at least one hydrolyzable group or hydroxy group and at least one nonhydrolyzable residue. Examples of the hydrolyzable group include a halogen, alkoxy group and acyloxy group. As the nonhydrolyzable residues, nonhydrolyzable residues having the reactive functional groups a and/or having no reactive functional groups a is used. Alternatively, there may be used silane at least partly having fluorine-substituted organic residues.

The silane used here is not particularly limited and may be, for example, CH₂═CHSi(OOCCH₃)₃, CH₂═CHSiCl₃, CH₂═CHSi(OC₂H₅)₃, CH₂—CH—Si(OC₂H₄OCH₃)₃, CH₂—CH—CH₂—Si (OC₂H₅)₃, CH₂═CH—CH₂—Si(OOCCH₃)₃, γ-glycidyloxypropyltrimethoxysilane (GPTS), γ-glycidyloxypropyldimethylchlorosilane, 3-aminopropyltrimethoxysilane (APTS), 3-aminopropyltriethoxysilane (APTES), N-(2-aminoethyl)-3-aminopropyltrimethoxysilane, N—[N′-(2′-aminoethyl)-2-aminoethyl]-3-aminopropyltrimethox ysilane, hydroxymethyltrimethoxysilane, 2-[methoxy(polyethyleneoxy)propyl]trimethoxysilane, bis-(hydroxyethyl)-3-aminopropyltriethoxysilane, N-hydroxyethyl-N-methylaminopropyltriethoxysilane, 3-(meth)acryloxypropyltriethoxysilane and 3-(meth)acryloxypropyltrimethoxysilane.

The silane-coupling agent is not particularly limited and may be a known one such as KBM-502, KBM-503, KBE-502, KBE-503 and KBM-5103 (product names; manufactured by: Shin-Etsu Chemical Co., Ltd.)

As the metallic compound having a functional group, there may be mentioned a metallic compound of a metal M selected from the primary groups III to V and/or the secondary groups II to IV of the periodical table of the elements. As such a metallic compound, for example, there may be mentioned zirconium alkoxide or titanium alkoxide and M(OR)₄ (M=Ti or Zr) wherein part of the OR group is replaced with a complexing agent such as a β-dicarbonyl compound or monocarboxylic acid. In the case of using a compound having a polymerizable unsaturated group (e.g., methacrylic acid) as the complexing agent, it is possible to introduce polymerizable unsaturated groups.

As the dispersion medium, water and/or an organic solvent is suitably used. An especially preferred dispersion medium is distilled (pure) water. As the organic solvent, a polar solvent, nonpolar solvent or aprotic solvent is preferred. Examples thereof include alcohols such as aliphatic alcohol having 1 to 6 carbon atoms (in particular, methanol, ethanol, n- (normal) and i- (iso) propanol and butanol); ketones such as acetone and butanone; esters such as ethyl acetate; ethers such as diethyl ether, tetrahydrofuran and tetrahydropyran; amides such as dimethylacetamide and dimethylformamide; sulfoxides and sulfones such as sulfolane and dimethylsulfoxide; and aliphatic (optionally halogenated) hydrocarbons such as pentane, hexane and cyclohexane. These dispersion media may be used as a mixture.

The dispersion medium preferably has a boiling point at which it can be easily removed by distillation (optionally under reduced pressure). Preferred as the dispersion medium is a solvent having a boiling point of 200° C. or less, particularly preferably 150° C. or less.

In preparation of the reactive, irregularly shaped silica fine particles (i), the concentration of the dispersion medium is normally from 40 to 90 wt %, preferably from 50 to 80 wt %, particularly preferably from 55 to 75 wt %. The rest of the dispersion is composed of untreated irregularly shaped silica fine particles and the above surface modification compound. Herein, the weight ratio of the untreated irregularly shaped silica fine particles to the surface modification compound is preferably from 100:1 to 4:1, more preferably from 50:1 to 8:1, still more preferably from 25:1 to 10:1.

Preparation of the reactive, irregularly shaped silica fine particles (i) is preferably carried out at a temperature from room temperature (about 20° C.) to the boiling point of the dispersion medium. The dispersion temperature is particularly preferably from 50 to 100° C. The dispersion time particularly depends on the kind of raw materials used, and is normally few hours such as 1 to 24 hours.

(ii) Irregularly shaped silica fine particles having reactive functional groups a on the surface thereof, which particles are obtained by bonding irregularly shaped silica fine particles that will be core particles to a compound containing reactive functional groups a that will be introduced onto the irregularly shaped silica fine particles to be covered, a group represented by the following chemical formula (1), and a silanol group or a group that is able to become a silanol group by hydrolysis:

-Q¹-C(=Q²)-Q³- Chemical Formula (1)

wherein Q¹ is NH, O (oxygen atom) or S (sulfur atom); Q² is O or S; and Q³ is NH or a divalent organic group.

Use of the reactive, irregularly shaped silica fine particles (ii) is advantageous in that the amount of the organic component is increased, so that the dispersibility of the reactive, irregularly shaped silica fine particles and the strength of a film are further increased.

Firstly, a compound having the reactive functional groups a which are required to be introduced onto the irregularly shaped silica fine particles to be covered, a group represented by the above chemical formula (1), and a silanol group or a group that is able to become a silanol group by hydrolysis will be described. Hereinafter, this compound may be referred to as reactive functional group modified hydrolyzable silane.

In the reactive functional group modified hydrolyzable silane, the reactive functional groups a which are required to be introduced onto the irregularly shaped silica fine particles are not particularly limited if they are appropriately selected so as to react with the binder component that will be described below. The reactive functional group modified hydrolyzable silane is suitable to introduce the above-mentioned polymerizable unsaturated groups.

In the reactive functional group modified hydrolyzable silane, as the [-Q¹-C(=Q²)-] moiety of the group represented by the above chemical formula (1), there may be mentioned the following six kinds, in particular: [—O—C(═O)—], [—O—C(═S)—], [—S—C(═O)—], [—NH—C(═O)—], [—NH—C(═S)—] and [—S—C(═S)—]. They may be used solely or in combination of two or more kinds. Especially from the viewpoint of thermal stability, as the [-Q¹-C(=Q²)-] moiety, it is preferable to use the [—O—C(═O)—] group in combination with at least one of the [—O—C(═S)—] and [—S—C(═O)—] groups. It is considered that the group represented by the above chemical formula (1), [-Q¹-C(=Q²)-Q³-], causes appropriate intermolecular cohesion by hydrogen bonding, and can impart properties such as excellent mechanical strength, adhesion to the substrate and heat resistance when forming a cured product.

As the group that is able to become a silanol group by hydrolysis, there may be mentioned groups having an alkoxy group, aryloxy group, acetoxy group, amino group, halogen atom or the like on a silicon atom. Preferred is an alkoxysilyl group or aryloxysilyl group. The silanol group or group that is able to become a silanol group by hydrolysis can be combined to the irregularly shaped silica fine particles by a condensation reaction that occurs after a condensation reaction or hydrolysis.

A preferred specific example of the reactive functional group modified hydrolyzable silane may be compounds represented by the following chemical formulae (2) and (3). Among them, the compound represented by the formula (3) is more preferably used from the viewpoint of the hardness of the hard coat layer:

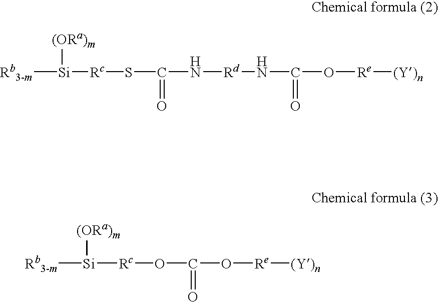

In the chemical formulae (2) and (3), R^{a} and R^{b} may be the same or different from each other, and are a hydrogen atom or a C₁-C₈ alkyl or aryl group such as a methyl, ethyl, propyl, butyl, octyl, phenyl and xylyl group; and m is 1, 2 or 3.

As the group represented by [(R^{a}O)ₘR^{b}₃₋ₘSi—], for example, there may be mentioned a trimethoxysilyl group, triethoxysilyl group, triphenoxysilyl group, methyldimethoxysilyl group and dimethylmethoxysilyl group. Among these groups, preferred are trimethoxysilyl and triethoxysilyl groups.

In the chemical formulae (2) and (3), R^{c} is a C₁-C₁₂ divalent organic group having an aliphatic or aromatic structure, and may contain a chain, branched or cyclic structure. As such an organic group, for example, there may be mentioned methylene, ethylene, propylene, butylene, hexamethylene, cyclohexylene, phenylene, xylylene and dodecamethylene. Among them, preferred are methylene, propylene, cyclohexylene and phenylene.

In the chemical formula (2), R^{d} is a divalent organic group and is normally selected from divalent organic groups having a molecular weight of 14 to 10,000, preferably a molecular weight of 76 to 500. For example, there may be mentioned a chain polyalkylene group such as hexamethylene, octamethylene and dodecamethylene; an alicyclic or polycyclic divalent organic group such as cyclohexylene and norbornylene; a divalent aromatic group such as phenylene, naphthylene, biphenylene and polyphenylene; and alkyl group-substituted derivatives and aryl group-substituted derivatives thereof. These divalent organic groups may contain an atom group that contains an element other than carbon and hydrogen atoms, and may further contain a polyether bond, a polyester bond, a polyamide bond, a polycarbonate bond, and a group represented by the chemical formula (1).

In the chemical formulae (2) and (3), R^{e} is a (n+1)-valent organic group and is preferably selected from a chain, branched or cyclic saturated or unsaturated hydrocarbon group.

In the chemical formulae (2) and (3), Y′ denotes a monovalent organic group having a reactive functional group a and may be the above-mentioned reactive functional group a. For example, in the case of selecting the reactive functional groups a from polymerizable unsaturated groups, there may be mentioned a (meth)acryloyl(oxy) group, vinyl(oxy) group, propenyl(oxy) group, butadienyl(oxy) group, styryl(oxy) group, ethinyl(oxy) group, cinnamoyl(oxy) group, maleate group, (meth)acrylamide group, etc. Preferably, n is a positive integer of 1 to 20, more preferably 1 to 10, particularly preferably 1 to 5.

Synthesis of the reactive functional group modified hydrolyzable silane used in the present invention may be performed by the method disclosed in, for example, Japanese Patent Application Laid-Open No. H9-100111. That is, for example, to introduce polymerizable unsaturated groups, the synthesis may be performed by: (A) addition reaction between mercaptoalkoxysilane, a polyisocyanate compound and an active hydrogen group-containing polymerizable unsaturated compound that is reactive with an isocyanate group. The synthesis may be also performed by (B) direct reaction between an active hydrogen group-containing polymerizable unsaturated compound and a compound having an alkoxysilyl group and isocyanate group in a molecule thereof. Furthermore, the reactive functional group modified hydrolyzable silane may be directly synthesized by (C) addition reaction between a compound having a polymerizable unsaturated group and isocyanate group in a molecule thereof and mercaptoalkoxysilane or aminosilane.

In the production of the reactive, irregularly shaped silica fine particles (ii), a method may be selected from the following: a method in which after the reactive functional group modified hydrolyzable silane is separately hydrolyzed, the resultant and irregularly shaped silica fine particles are mixed together, followed by heating and stirring; a method in which the reactive functional group modified hydrolyzable silane is hydrolyzed in the presence of irregularly shaped silica fine particles; and a method in which a surface treatment is performed on irregularly shaped silica fine particles in the presence of other component such as a polyvalent unsaturated organic compound, a monovalent unsaturated organic compound and a radiation polymerization initiator. Preferred is the method in which the reactive functional group modified hydrolyzable silane is hydrolyzed in the presence of irregularly shaped silica fine particles. In the production of the reactive, irregularly shaped silica fine particles (ii), the production temperature is normally 20° C. or more and 150° C. or less, and the treating time is in the range from 5 minutes to 24 hours.

To accelerate the hydrolysis reaction, an acid, salt or base may be added as a catalyst. Suitable examples of the acid include an organic acid and unsaturated organic acid. Suitable examples of the base include a tertiary amine and quaternary ammonium hydroxide. The added amount of the acid or base catalyst is from 0.001 to 1.0 wt %, preferably from 0.01 to 0.1 wt % with respect to the reactive functional group modified hydrolyzable silane.

As the reactive, irregularly shaped silica fine particles, there may be used powder particles containing no dispersion medium; however, it is preferable to use a sol comprising fine particles dispersed in a solvent because the dispersion process can be omitted and high productivity can be obtained.

The method for producing the irregularly shaped silica fine particles is not particularly limited. It may be appropriately selected from conventionally known methods as long as it is possible to obtain silica fine particles connected to each other by inorganic chemical bonding. For example, the irregularly shaped silica fine particles can be obtained by performing a hydrothermal treatment at a high temperature of 100° C. or more on a monodisperse silica fine particle dispersion liquid after controlling the concentration or pH of the liquid. At this time, a binder component may be added as needed to promote the bonding of the silica fine particles. Also, the silica fine particles dispersion liquid to be used may be filtered through an ion-exchange resin to remove ions. The bonding of the silica fine particles can be promoted by such an ion-exchange treatment. After the hydrothermal treatment, another ion-exchange treatment may be performed thereon.

In addition to the reactive, irregularly shaped silica fine particles, reactive spherical silica fine particles having an average primary particle diameter from 1 to 100 nm may be contained without departing from the scope of the present invention. In the case where the reactive spherical silica fine particles are additionally contained, from the viewpoint of increasing the abrasion resistance and hardness of the hard coat layer, the content of the reactive, irregularly shaped silica fine particles is preferably 50 wt % or more, more preferably 80 wt % or more, with respect to the total content of the two kinds of reactive silica fine particles.

Commercial products of the reactive, irregularly shaped silica fine particles include, for example, DP1039, DP1040, DP1071, DP1072, DP1073 and so on (product names; manufactured by: JGC Catalysts and Chemicals Ltd.)

### (Binder Component)

The binder component used in the curable resin composition for a hard coat layer is a component that has reactive functional groups b and causes cross-linking reaction by itself when cured, thereby serving as a matrix of the hard coat layer. The reactive functional groups b have cross-linking reactivity with the reactive functional groups a of the reactive, irregularly shaped silica fine particles, so that the binder component is cross-linked with the reactive, irregularly shaped silica fine particles to form a network structure, thereby further increasing the abrasion resistance and hardness of the hard coat layer.

As the reactive functional groups b, polymerizable unsaturated groups are suitably used. Preferred are photocurable unsaturated groups, and particularly preferred are ionizing radiation-curable unsaturated groups. Specific examples thereof include an ethylene double bond such as a (meth)acryloyl group, a vinyl group and an allyl group, and an epoxy group.

The reactive functional groups b may be the same as or different from the reactive functional groups a.

The binder component is preferably a curable organic resin, which is preferably an optically-transparent resin that can pass light through when formed into a coating film, and may be appropriately selected from ionizing radiation-curable resins which are curable upon exposure to ionizing radiation typified by ultraviolet light or electron beams, or other known curable resins depending on the performance required for the optical sheet. As the ionizing radiation-curable resin, for example, there may be mentioned acrylate, oxetane or silicone resin.

As the binder component, one binder component may be used solely, or two or more kinds of binder components may be used in combination.

The binder component preferably has three or more reactive functional groups b so that the cross-linking density can be increased.

As the binder component having three or more reactive functional groups b (tri- or more functional binder component), for example, there may be mentioned pentaerythritol tri(meth)acrylate, pentaerythritol tetra(meth)acrylate, dipentaerythritol hexa(meth)acrylate, dipentaerythritol penta(meth)acrylate, trimethylolpropane tri(meth)acrylate, trimethylolpropane hexa(meth)acrylate, and modified products thereof.

As the modified products, there may be mentioned EO (ethylene oxide)-modified products, PO (propylene oxide)-modified products, CL (caprolactone)-modified products and isocyanuric acid-modified products, for example.

As the binder component, there may be also used a compound having a molecular weight of 10,000 or more, three or more functional groups, and a similar framework to that of a compound which will be described hereinafter, compound (B). The compound (B) has a molecular weight of less than 10,000 and two or more reactive functional groups b. Examples of such a compound include BEAMSET 371 (product name; manufactured by: Arakawa Chemical Industries, Ltd.)

As the binder component, pentaerythritol triacrylate, pentaerythritol tetra(meth)acrylate, dipentaerythritol hexaacrylate, pentaerythritol tetraacrylate and dipentaerythritol pentaacrylate are suitably used. Particularly preferred are dipentaerythritol hexaacrylate, pentaerythritol tetraacrylate and dipentaerythritol pentaacrylate.

Furthermore, from the viewpoint of increasing the hardness of the hard coat layer, as the binder component, it is preferable to use a polyalkylene oxide chain-containing polymer (A) represented by the following chemical formula (4) in combination with the compound (B) having a molecular weight of less than 10,000 and two or more reactive functional groups b.

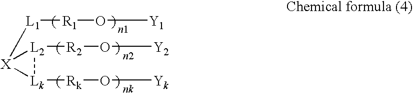

wherein X is solely a straight, branched or cyclic hydrocarbon chain solely or a combination of any of straight, branched and cyclic hydrocarbon chains; the hydrocarbon chain may have a substituent; a heteroatom may be contained between the hydrocarbon chains; the hydrocarbon chain is a trivalent or more organic group having 3 to 10 carbon atoms excluding the substituent; k denotes an integer from 3 to 10; each of L₁ to Lₖ is independently a direct bond or a divalent group having one or more kinds of bonds selected from the group consisting of an ether bond, ester bond and urethane bond; each of R₁ to Rₖ is independently a straight-chain or branched hydrocarbon group having 1 to 4 carbon atoms; each of n1, n2 to nk is an independent number; and each of Y₁ to Yₖ independently denotes a compound residue having one or more reactive functional groups b.

The polymer (A), the compound (B) and the reactive, irregularly shaped silica fine particles are reactive with each other. It is presumed that because the polymer (A) is cross-linked to the compound (B) and the reactive, irregularly shaped silica fine particles, the optical sheet can be imparted with abrasion resistance and hardness.

### (Polyalkylene Oxide Chain-Containing Polymer (A) Represented by Chemical Formula (4))

The polyalkylene oxide chain-containing polymer (A) is a polyalkylene oxide chain-containing polymer having a molecular weight of 1,000 or more and three or more reactive functional groups b at the end positions thereof, and is represented by the following chemical formula (4):

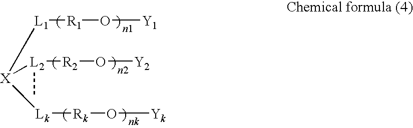

wherein X is solely a straight, branched or cyclic hydrocarbon chain solely or a combination of any of straight, branched and cyclic hydrocarbon chains; the hydrocarbon chain may have a substituent; a heteroatom may be contained between the hydrocarbon chains; the hydrocarbon chain is a trivalent or more organic group having 3 to 10 carbon atoms excluding the substituent; k denotes an integer from 3 to 10; each of L₁ to Lₖ is independently a direct bond or a divalent group having one or more kinds of bonds selected from the group consisting of an ether bond, ester bond and urethane bond; each of R₁ to Rₖ is independently a straight-chain or branched hydrocarbon group having 1 to 4 carbon atoms; each of n1, n2 to nk is an independent number; and each of Y₁ to Yₖ independently denotes a compound residue having one or more reactive functional groups b.

In the chemical formula (4), X is solely a straight, branched or cyclic hydrocarbon chain solely or a combination of any of straight, branched and cyclic hydrocarbon chains; the hydrocarbon chain may have a substituent; a heteroatom may be contained between the hydrocarbon chains; and the hydrocarbon chain is a trivalent or more organic group having 3 to 10 carbon atoms excluding the substituent. In the polyalkylene oxide chain-containing polymer (A) represented by the chemical formula (4), X corresponds to a short main chain having k branching point(s) (k denotes the number of the branching point(s)). From the branching point(s), a polyalkylene oxide chain portion (O—Rₖ)ₙₖ is branched, which is a linear side chain.

The hydrocarbon chain contains a saturated hydrocarbon like —CH₂— or an unsaturated hydrocarbon like —CH═CH—. The cyclic hydrocarbon chain may comprise an alicyclic compound or aromatic compound. A heteroatom such as O and S may be contained between the hydrocarbon chains, and an ether bond, ester bond, urethane bond or the like may be also contained between the hydrocarbon chains. A hydrocarbon chain that is branched from the straight or cyclic hydrocarbon chain via a heteroatom is included in the number of carbons of a substituent that will be described below.

Specific examples of the substituent that may be contained in the hydrocarbon chain include a halogen atom, hydroxyl group, carboxyl group, amino group, epoxy group, isocyanate group, mercapto group, cyano group, silyl group, silanol group, nitro group, acetyl group, acetoxy group and sulfonic group. The substituent is not limited to the above examples, however. As mentioned above, the substituent that may be contained in the hydrocarbon chain also contains said hydrocarbon chain that is branched from the straight or cyclic hydrocarbon via a heteroatom, such as an alkoxy group (RO—, wherein R is a straight, branched or cyclic saturated or unsaturated hydrocarbon chain), an alkylthioether group (RS—, wherein R is a straight, branched or cyclic saturated or unsaturated hydrocarbon chain) and an alkyl ester group (RCOO—, wherein R is a straight, branched or cyclic saturated or unsaturated hydrocarbon chain).

X is a trivalent or more organic group having 3 to 10 carbon atoms excluding the substituent. In X, if the number of the carbon atoms excluding the substituent is less than 3, it becomes difficult to have three or more polyalkylene oxide chain portions (O—Rₖ)ₙₖ, which are linear side chains. On the other hand, if the number of the carbon atoms exceeds 10, there are more soft parts in a cured film and the hardness of the film is thus decreased, which is not preferable. The number of the carbon atoms excluding the substituent is preferably 3 to 7, more preferably 3 to 5.

X is not particularly limited if the above conditions are met. As X, for example, there may be mentioned one having any of the following structures:

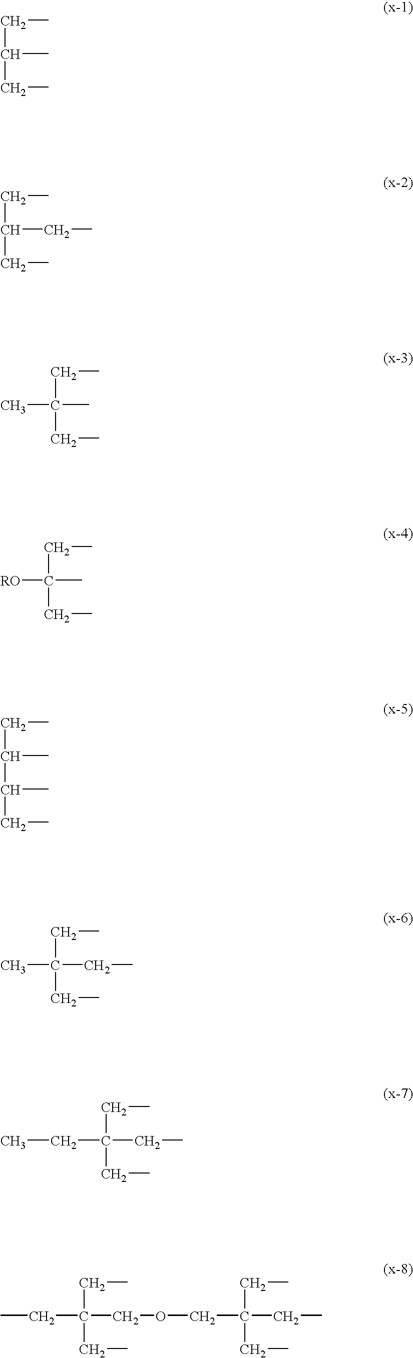

As the particularly preferred structure, there may be mentioned the above structures (x-1), (x-2), (x-3), (x-7), etc.

Materials that are suitably used as the material of X include, for example, polyalcohols which have three or more hydroxyl groups in a molecule thereof and 3 to 10 carbon atoms, such as 1,2,3-propanetriol (glycerol), trimethylolpropane, pentaerythritol and dipentaerythritol; polycarboxylic acids which have three or more carboxyl groups in a molecule thereof and 3 to 10 carbon atoms; and C3-C10 multiamine acids having three or more amino groups in a molecule thereof.

In the chemical formula (4), k denotes the number of the polyalkylene oxide chain (O—Rₖ)ₙₖ in a molecule, which is an integer from 3 to 10. If k is less than 3, that is, if the number of the polyalkylene oxide chain is 2, no sufficient hardness can be obtained. If k exceeds 10, there are more soft parts in a cured film and the hardness of the film is thus decreased, which is not preferable. Preferably, k is 3 to 7. More preferably, k is 3 to 5.

In the chemical formula (4), each of L₁ to Lₖ is independently a direct bond or a divalent group having one or more kinds of bonds selected from the group consisting of an ether bond, ester bond and urethane bond. The divalent group having one or more kinds of bonds selected from the group consisting of an ether bond, ester bond and urethane bond may be an ether bond (—O—), ester bond (—COO—) or urethane bond (—NHCOO—) itself. Because of these bonds, the molecular chain of these bonds can be easily lengthened and is thus highly flexible, so that it is easy to obtain high compatibility with other resin components.

As the divalent group having one or more kinds of bonds selected from the group consisting of an ether bond, ester bond and urethane bond, for example, there may be mentioned —O—R—O—, —O(C═O)—R—O—, —O(C═O)—R—(C═O)O—, —(C═O)O—R—O—, —(C═O)O—R—(C═O)O—, —(C═O)O—R—O(C═O)—, —NHCOO—R—O—, —NHCOO—R—O(C═O)NH—, —O(C═O)NH—R—O—, —O(C═O)NH—R—O (C═O)NH—, —NHCOO—R—O(C═O)NH—, —NHCOO—R—(C═O)O—, —O(C═O)NH—R—(C═O)O—, —NHCOO—R—O(C═O)— and —O(C═O)NH—R—O(C═O)—. The R used here denotes a straight, branched or cyclic, saturated or unsaturated hydrocarbon chain.

Specific examples of the divalent group include residues formed by removing active hydrogens from a diol (such as (poly)ethylene glycol and (poly)propylene glycol), dicarboxylic acid (such as fumaric acid, maleic acid and succinic acid), and diisocyanate (such as tolylene diisocyanate, hexamethylene diisocyanate and isophorone diisocyanate). The divalent group is not limited to the above examples, however.

In the chemical formula (4), (O—Rₖ)ₙₖ is a polyalkylene oxide chain which is a linear side chain having alkylene oxide as the repeating unit. Herein, each of R₁ to Rₖ is independently a straight-chain or branched hydrocarbon group having 1 to 4 carbon atoms. As the alkylene oxide, for example, there may be mentioned methylene oxide, ethylene oxide, propylene oxide and isobutylene oxide. Suitably used as the alkylene oxide are ethylene oxide and propylene oxide, which are a straight-chain or branched hydrocarbon group having 2 to 3 carbon atoms.

In the chemical formula (4), each of n1, n2 to nk is the number of the repeating unit of alkylene oxide Rₖ—O, and is an independent number. No particular limitation is imposed on n1, n2 to nk as long as the weight average molecular weight of all the molecules is 1,000 or more. Each of n1, n2 to nk may be different; however, their chain lengths are preferably almost equal from the viewpoint of preventing the hard coat layer from cracking with retaining the original hardness of the hard coat layer when it was formed. Therefore, the difference in the repeating units between n1 to nk is preferably about 0 to 100, more preferably about 0 to 50, particularly preferably about 0 to 10.

From the viewpoint of preventing the hard coat layer from cracking with retaining the original hardness of the hard coat layer when it was formed, each of n1, n2 to nk is preferably a number of 2 to 500, more preferably a number of 2 to 300.

Each of Y₁ to Yₖ independently denotes a reactive functional group b or a compound residue having one or more reactive functional groups b. Because of this, three or more reactive functional groups b are provided to the end positions of the polyalkylene oxide chain-containing polymer.

In the case where each of Y₁ to Yₖ is a reactive functional group b itself, as each of Y₁ to Yₖ, for example, there may be mentioned a polymerizable unsaturated group such as a (meth)acryloyl group and a vinyl group (CH₂═CH—).

In the case where each of Y₁ to Yₖ is a compound residue having one or more reactive functional groups b, as the one or more reactive functional groups b, for example, there may be mentioned polymerizable unsaturated groups such as a (meth)acryloyloxy group, CH₂═CR— (wherein R is a hydrocarbon group). No particular limitation is imposed on the compound residue as long as the one or more reactive functional groups b are appropriately selected so as to be reactive with the reactive, irregularly shaped silica fine particles and/or the compound (B) that will be described below. In the case where each of Y₁ to Yₖ is a compound residue, the number of the reactive functional group(s) b of Y₁ to Yₖ may be one; however, from the viewpoint of abrasion resistance and hardness of the resulting hard coat layer, the number is more preferably two or more, so that the cross-linking density of the hard coat layer is increased further.

In the case where each of Y₁ to Yₖ is a compound residue having one or more reactive functional groups b, the compound residue is a residue formed by removing, from a compound which has at least one or more reactive functional groups b and a different reactive substituent, the reactive substituent or part of the reactive substituent (such as hydrogen).

For example, as a compound residue having an ethylenically unsaturated group, there may be mentioned in particular a residue formed by removing, from each of the following compounds, a reactive substituent other than the ethylenically unsaturated group or part of the reactive substituent (such as hydrogen): (meth)acrylic acid, hydroxyethyl(meth)acrylate, hydroxypropyl(meth)acrylate, pentaerythritol tri(meth)acrylate, etc. The compound residue having an ethylenically unsaturated group is not limited to the above examples, however.

The molecular weight of the polyalkylene oxide chain-containing polymer (A) used in the present invention is 1,000 or more, preferably 5,000 or more, particularly preferably 10,000 or more, from the viewpoint of imparting flexibility to a cured layer and preventing the same from cracking.

Commercial products containing the polyalkylene oxide chain-containing polymer (A) represented by the chemical formula (4) include, for example, DIABEAMUK-4153 (product name; manufactured by: Mitsubishi Rayon Co., Ltd.; in the chemical formula (4), X is (x-7); k is 3; each of L₁ to L₃ is a direct bond; each of R₁ to R₃ is ethylene; the total of n1, n2 and n3 is 20; and each of Y₁ to Y₃ is an acryloyloxy group.)

The content of the polymer (A) is preferably 5 to 100 parts by weight, more preferably 10 to 50 parts by weight, with respect to 100 parts by weight of the compound (B) that will be described below. If the content of the polymer (A) is 5 parts by weight or more with respect to 100 parts by weight of the polymer (B), flexibility and stability can be imparted to a cured film. If the content is 100 parts by weight or less, a cured film can retain its hardness.

(Compound (B) Having a Molecular Weight of Less than 10,000 and Two or More Reactive Functional Groups B)

The compound (B) having a molecular weight of less than 10,000 and two or more reactive functional groups b increases the hardness of the hard coat layer in corporation with the reactive, irregularly shaped silica fine particles, thereby imparting sufficient abrasion resistance and hardness to the hard coat layer. One having the structure of the polymer (A) is, however, excluded from the compound (B) having a molecular weight of less than 10,000 and two or more reactive functional groups b.

In the present invention, the compound (B) may be selected from a wide range of compounds having sufficient abrasion resistance and reactive functional groups b which are, when combined with the polymer (A) and the reactive, irregularly shaped silica fine particles, reactive with them. The compound (B) may be a single compound or a mixture of two or more kinds of compounds.

In the compound (B) having a molecular weight of less than 10,000 and two or more reactive functional groups b, from the viewpoint of increasing the cross-linking density of a cured film and imparting hardness to the film, the number of the functional groups b which are contained in one molecule is preferably three or more. When the compound (B) is an oligomer having a molecular weight distribution, the number of the reactive functional groups b is expressed by an average number.

The molecular weight of the compound (B) is preferably less than 5,000 from the viewpoint of increasing the hardness of the hard coat layer.

Specific examples of the compound (B) are listed below; however, the compound (B) used in the present invention is not limited to the following examples.

As the compounds having polymerizable unsaturated groups, firstly, there may be mentioned polyfunctional (meth)acrylate monomers having two or more polymerizable unsaturated groups. The polyfunctional (meth)acrylate monomers include, for example, difunctional (meth)acrylate compounds (that is, (meth) acrylate compounds having two or more reactive functional groups) such as 1,6-hexanediol di(meth)acrylate, neopentyl glycol di(meth)acrylate, ethylene glycol di(meth)acrylate, and isocyanuric acid ethylene oxide-modified di(meth)acrylate; trifunctional (meth)acrylate compounds such as trimethylolpropane tri(meth)acrylate and EO-, PO-, and epichlorohydrin-modified products thereof, pentaerythritol tri(meth)acrylate, glycerol tri(meth)acrylate and EO-, PO-, and epichlorohydrin-modified products thereof, isocyanuric acid EO-modified tri(meth)acrylate (product name: ARONIX M-315 or the like; manufactured by: TOAGOSEI Co., Ltd.), tris(meth)acryloyl oxyethyl phosphate, phthalic acid-hydrogen-(2,2,2-tri-(meth)acryloyloxymethyl)ethyl; tetrafunctional (meth)acrylate compounds such as pentaerythritol tetra(meth)acrylate and EO-, PO-, and epichlorohydrin-modified products thereof and ditrimethylolpropane tetra(meth)acrylate; pentafunctional (meth)acrylate compounds such as dipentaerythritol penta(meth)acrylate and EO-, PO-, epichlorohydrin-, fatty acid-, alkyl-, and urethane-modified products thereof; hexafunctional (meth)acrylate compounds such as dipentaerythritol hexa(meth) acrylate and EO-, PO-, epichlorohydrin-, fatty acid-, alkyl-, and urethane-modified products thereof, and sorbitol hexa(meth)acrylate and EO-, PO-, epichlorohydrin-, fatty acid-, alkyl-, and urethane-modified products thereof.

Also, as the compounds having polymerizable unsaturated groups, there may be mentioned tri- or more functional acrylate resins. Commercial products may be used as the tri- or more functional acrylate resins, and specific examples thereof include: DPHA, PET30, GP0303, TMPTA, THE330, TPA330, D310, D330, PM2, PM21, DPCA20, DPCA30, DPCA60, DPCA120, etc., in the KAYARAD and KAYAMER series (product names; manufactured by: Nippon Kayaku Co., Ltd.); M305, M309, M310, M315, M320, M327, M350, M360, M402, M408, M450, M7100, M7300K, M8030, M8060, M8100, M8530, M8560, M9050, etc., in the ARONIX series (product names; manufactured by: TOAGOSEI Co., Ltd.); TMPT, A-TMPT, A-TMM-3, A-TMM3L, A-TMMT, A-TMPT-6EO, A-TMPT-3CL, A-GLY-3E, A-GLY-6E, A-GLY-9E, A-GLY-11E, A-GLY-18E, A-GLY-20E, A-9300, AD-TMP-4CL, AD-TMP, etc., in the NK Ester series (product names; manufactured by: Shin-Nakamura Chemical Co., Ltd.); ADP51, ADP33, ADP42, ADP26, ADP15, etc., in the NK Economer series (product names; manufactured by: Shin-Nakamura Chemical Co., Ltd.); TMPT, TMP3, TMP15, TMP2P, TMP3P, PET3, TEICA, etc., in the New Frontier series (product names; manufactured by: Dai-Ichi Kogyo Seiyaku Co., LTD.); TMPTA, TMPTAN, 160, TMPEOTA, OTA480, 53, PETIA, 2047, 40, 140, 1140, PETAK, DPHA, etc., in the Ebecryl series (product names; manufactured by: DAICEL-CYTEC Co., Ltd.); and CD501, CD9021, CD9052, SR351, SR351HP, SR351LV, SR368, SR368D, SR415, SR444, SR454, SR454HP, SR492, SR499, SR502, SR9008, SR9012, SR9020, SR9020HP, SR9035, CD9051, SR350, SR9009, SE9011, SR295, SR355, SR399, SR399LV, SR494 and SR9041 (product names; manufactured by: Sartomer Company, Inc.)

Also, as the compounds having polymerizable unsaturated groups, there may be mentioned (meth)acrylate oligomers (or prepolymers). The (meth)acrylate oligomers (or prepolymers) include, for example, an epoxy (meth)acrylate obtained by addition reaction of a glycidyl ether with a (meth) acrylic acid or a monomer having a carboxylic acid base; a urethane (meth)acrylate obtained by addition reaction of a (meth)acrylate having a hydroxyl group with a reactant of a polyol and a polyisocyanate; an polyester acrylate obtained by esterification of a (meth) acrylic acid with a polyester polyol obtained from a polyol and a polyprotic acid; and a polybutadiene (meth)acrylate which is a (meth)acrylic compound having the polybutadiene or a hydrogenated butadiene skeleton. If the reactive functional groups b of an essential component of the present invention are polymerizable unsaturated groups, urethane (meth)acrylate is especially preferably used in this case because it can impart hardness and flexibility to a cured film.

As the glycidyl ether used in the epoxy (meth)acrylate, for example, there may be mentioned 1,6-hexanediglycidyl ether, polyethyleneglycol glycidyl ether, bisphenol A type epoxy resin, naphthalene type epoxy resin, cardo epoxy resin, glycerol triglycidyl ether and phenolic novolac type epoxy resin.

As the polyol used in the urethane (meth)acrylate, for example, there may be mentioned 1,6-hexanediglycidyl ether, polyethylene glycol, polypropylene glycol, polytetramethylene glycol, polycaprolactone diol, polycarbonate diol, polybutadiene polyol and polyester diol. As the polyisocyanate used in the urethane (meth)acrylate, for example, there may be mentioned tolylene diisocyanate, xylylene diisocyanate, diphenylmethane diisocyanate, tetramethylxylene diisocyanate, hexamethylene diisocyanate, isophorone diisocyanate and dicyclohexylmethane diisocyanate. As the (meth)acrylate having hydroxyl group used in the urethane (meth)acrylates, for example, there may be mentioned 2-hydroxyethyl (meth)acrylate, 2-hydroxypropyl (meth)acrylate, 4-hydroxybutyl (meth)acrylate, pentaerythritol (meth)acrylate and caprolactone-modified 2-hydroxyethyl(meth)acrylate.

As the polyol used to produce the polyester polyol used in the polyester acrylates, for example, there may be mentioned ethylene glycol, polyethylene glycol, propylene glycol, polypropylene glycol, neopentyl glycol, 1,4-butanediol, trimethylolpropane and pentaerythritol. As the polyprotic acid, for example, there may be mentioned succinic acid, adipic acid, sebacic acid, phthalic acid, isophthalic acid, terephthalic acid, trimellitic acid and pyromellitic acid.

As the compound (B) used in the present invention, a polymer which is represented by the following chemical formula (5) and has a molecular weight of less than 10,000 may be also used:

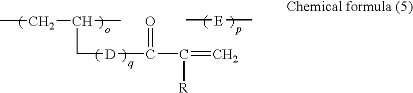

wherein D denotes a linking group having 1 to 10 carbon atoms; q denotes 0 or 1; R denotes a hydrogen atom or methyl group; E denotes the polymeric unit of an optional vinyl monomer and may comprise a single component or a plurality of components; o and p each denote the mol % of each polymeric unit; and p may be 0.

D in the chemical formula (5) denotes a linking group having 1 to 10 carbon atoms, preferably a linking group having 1 to 6 carbon atoms, particularly preferably a linking group having 2 to 4 carbon atoms. D may have a straight-chain, branched or cyclic structure. D may have a hetero atom selected from O, N and S.

Preferred as the linking group D in the chemical formula (5) are, for example, *—(CH₂)₂—O—**, *—(CH₂)₂—NH—**, * —(OH₂)₄—O—**, *—CH₂)₆—O—**, *—CH₂)₂—O—(CH)₂—O—**, * —CONH— (CH₂)₃—O—**, *—CH₂CH(OH)CH₂—O—** and * —CH₂CH₂OCONH(CH₂)₃—O—**. The * used here represents a site linked to the main chain of the polymer represented by the chemical formula (5), and the ** represents a site linked to a (meth)acryloyl group.

In the chemical formula (5), R denotes a hydrogen atom or methyl group. From the viewpoint of curing reactivity, R is preferably a hydrogen atom.

In the chemical formula (5), o may be 100 mol %, that is, a single polymer; moreover, o may be 100 mol % or a copolymer produced by mixing two or more kinds of polymeric units which are represented by o mol % and contain a (meth) acryloyl group. The ratio of o to p is not particularly limited and may be appropriately selected from the viewpoints of hardness, solubility in a solvent, optical transparency, etc.

In the chemical formula (5), E means the polymeric unit of an optional vinyl monomer. E is not particularly limited and may be appropriately selected from the viewpoints of hardness, solubility in a solvent, optical transparency, etc. Furthermore, E may comprise a single vinyl monomer or a plurality of vinyl monomers depending on the intended purpose.

As the vinyl monomer, for example, there may be mentioned vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate; (meth)acrylates such as methyl (meth)acrylate, ethyl (meth)acrylate, hydroxyethyl (meth)acrylate, glycidyl (meth)acrylate, allyl (meth)acrylate and (meth) acryloyloxypropyltrimethoxysilane; styrene derivatives such as styrene and p-hydroxymethylstyrene; and unsaturated carboxylic acids such as crotonic acid, maleic acid and itaconic acid, and derivatives thereof.

As the compound (B), reactive oligomers may be used, which have a weight average molecular weight of less than 10,000 and an ethylenically unsaturated bond at the end positions thereof or as a side chain thereof. As the reactive oligomers, for example, there may be mentioned resins having, as the framework component, any of poly(methyl methacrylate), polystyrene, poly(butyl methacrylate), poly(acrylonitrile/styrene), or poly(2-hydroxymethyl (meth)acrylate/methyl (meth)acrylate), poly(2-hydroxymethyl (meth)acrylate/butyl (meth)acrylate), and copolymers of these resins with a silicone resin.

As the above-mentioned compounds, commercial products may be used. As urethane acrylates which have a weight average molecular weight of less than 10,000 and two or more polymerizable unsaturated groups, for example, there may be mentioned AH-600, AT-600, UA-306H, UA-306T and UA-306I (product names; manufactured by: Kyoeisha Chemical Co., Ltd.) As a urethane (meth)acrylate that is suitably used in combination with the polymer (A), for example, there may be mentioned a urethane (meth)acrylate which is obtained by reaction between a monomer or multimer of isophorone diisocyanate, pentaerythritol polyfunctional acrylate and dipentaerythritol polyfunctional acrylate. Commercial products of the urethane (meth)acrylate include, for example, UV-1700B (product name; manufactured by: The Nippon Synthetic Chemical Industry Co., Ltd.)

Commercial products may be used as a urethane (meth)acrylate resin. In particular, for example, there may be mentioned: UV1700B, UV6300B, UV765B, UV7640B, UV7600B and so on in the Shiko series (product names; manufactured by: The Nippon Synthetic Chemical Industry Co., Ltd.); Art Resin HDP, Art Resin UN9000H, Art Resin UN3320HA, Art Resin UN3320HB, Art Resin UN3320HC, Art Resin UN3320HS, Art Resin UN901M, Art Resin UN902MS, Art Resin UN903 and so on in the Art Resin series (product names; manufactured by: Negami Chemical industrial Co., Ltd.); UA100H, U4H, U6H, U15HA, UA32P, U6LPA, U324A, U9HAMI and so on (product names; manufactured by: Shin-Nakamura Chemical Co., Ltd.); 1290, 5129, 254, 264, 265, 1259, 1264, 4866, 9260, 8210, 204, 205, 6602, 220, 4450 and so on in the Ebecryl series (product names; manufactured by: DAICEL-CYTEC Co., Ltd.); 577, 577BV, 577AK and so on in the BEAMSET series (product names; manufactured by: Arakawa Chemical Industries, Ltd.); the RQ series (product name; manufactured by: Mitsubishi Rayon Co., Ltd.); the UNIDIC series (product name; manufactured by: DIC Corporation); DPHA40H (product name; manufactured by: Nippon Kayaku Co., Ltd.); and CN9006 and CN968 (product names; manufactured by: Sartomer Company, Inc.) Among them, preferred are UV1700B (product name; manufactured by: The Nippon Synthetic Chemical Industry Co., Ltd.), DPHA40H (product name; manufactured by: Nippon Kayaku Co., Ltd.), Art Resin HDP (product name; manufactured by: Negami Chemical industrial Co., Ltd.), BEAMSET 577 (product name; manufactured by: Arakawa Chemical Industries, Ltd.) and U15HA (product name; manufactured by: Shin-Nakamura Chemical Co., Ltd.)

As epoxy acrylates that have a weight average molecular weight of less than 10,000 and two or more polymerizable unsaturated groups, for example, there may be mentioned: SP-4060, SP-1450 and so on in the SP series and VR-60, VR-1950, VR-90, VR-1100 and so on in the VR series (product names; manufactured by: Showa Highpolymer Co., Ltd.); UV-9100B, UV-9170B and so on (product names; manufactured by: The Nippon Synthetic Chemical Industry Co., Ltd.); and EA-6320/PGMAc, EA-6340/PGMAc and so on (product names; manufactured by: Shin-Nakamura Chemical Co., Ltd.)

As reactive oligomers that have a weight average molecular weight of less than 10,000 and two or more polymerizable unsaturated groups, for example, there may be mentioned AA-6, AS-6, AB-6, AA-714SK and so on in the Macromonomer series (product names; manufactured by: TOAGOSEI Co., Ltd.)

In consideration of curling and cracking properties of the hard coat layer, a compound which comprises the same repeating unit as that of the chemical formula (5) and has a molecular weight of 10,000 or more and less than 100,000 may be added as a binder component.

Examples of the binder component having a molecular weight of 10,000 or more and less than 100,000 include BS371, BS371MLV, DK1, DK2, DK3 and so on (product names; manufactured by: Arakawa Chemical Industries, Ltd.)

### (Other Components)

In addition to the above components, a solvent, polymerization initiator, anti-static agent, anti-glare agent, etc., may be appropriately added to the curable resin composition for a hard coat layer. Furthermore, the composition may be mixed with various kinds of additives such as a reactive or non-reactive leveling agent and various kinds of sensitizers. In the case of containing an anti-static agent and/or anti-glare agent, anti-static properties and/or anti-glare properties may be further imparted to the hard coat layer.

### (Solvent)

The solvent is not particularly limited and may be appropriately selected in consideration of the dispersibility or coatability of the reactive, irregularly shaped silica fine particles. From the viewpoint of adhesion and prevention of fringes, a penetrable solvent is preferred. From the viewpoint of increasing the hardness of the optical sheet, an impenetrable solvent is preferred. In the present invention, penetration (penetrable) means dissolving or swelling a substrate.

In the case where the substrate is a triacetyl cellulose film (TAC film), as the impenetrable solvent, there may be mentioned methyl isobutyl ketone, propylene glycol monomethyl ether, n-propanol, isopropanol, n-butanol, sec-butanol, isobutanol and tert-butanol, for example. As the penetrable solvent, for example, there may be mentioned ketone solvents such as methyl ethyl ketone and ester solvents such as ethyl acetate.

### (Polymerization Initiator)

To initiate or promote the polymerization of the above-mentioned radical polymerizable functional group or cationic polymerizable functional group, a radical polymerization initiator, cationic polymerization initiator, radical and cationic polymerization initiator or the like may be appropriately selected for use, if necessary. These polymerization initiators are decomposed by light irradiation and/or heating to produce radicals or cations, thereby promoting radical polymerization and/or cationic polymerization.

The radical polymerization initiator usable in the present invention is needed to be able to release a substance which can initiate radical polymerization by light irradiation and/or heating. As the radical polymerization initiator, for example, there may be mentioned imidazole derivatives, bisimidazole derivatives, N-aryl glycine derivatives, organic azide compounds, titanocenes, aluminate complexes, organic peroxides, N-alkoxypyridinium salts and thioxanthone derivatives. In particular, for example, there may be mentioned 1,3-di(tert-butyldioxycarbonyl)benzophenone, 3,3′,4,4′-tetrakis(tert-butyldioxycarbonyl)benzophenone, 3-phenyl-5-isoxazolone, 2-mercapto benzimidazole, bis(2,4,5-triphenyl)imidazole, 2,2-dimethoxy-1,2-diphenylethane-1-on (product name: Irgacure 651; manufactured by: Ciba Japan K.K.), 1-hydroxy-cyclohexyl-phenyl-ketone (product name: Irgacure 184; manufactured by: Ciba Japan K.K.), 2-benzyl-2-dimethylamino-1-(4-morpholinophenyl)-butane-1-o n (product name: Irgacure 369; manufactured by: Ciba Japan K.K.), bis(η⁵-2,4-cyclopentadiene-1-yl)-bis(2,6-difluoro-3-(1H-py rrole-1-yl)-phenyl)titanium) (product name: Irgacure 784; manufactured by: Ciba Japan K.K.) The radical polymerization initiator usable in the present invention is not limited to the above examples, however.

Besides the above examples, commercial products may be used as the radical polymerization initiator, such as Irgacure 907, Irgacure 379, Irgacure 819, Irgacure 127, Irgacure 500, Irgacure 754, Irgacure 250, Irgacure 1800, Irgacure1870, Irgacure OXE01, DAROCUR TPO and DAROCUR 1173 (product names; manufactured by: Ciba Japan K.K.); Speedcure MBB, Speedcure PBZ, Speedcure ITX, Speedcure CTX, Speedcure EDB, Esacure ONE, Esacure KIP150 and Esacure KT046 (product names; manufactured by: DKSH Japan K.K.); and KAYACURE DETX-S, KAYACURECTX, KAYACURE BMS and KAYACURE DMBI (product names; manufactured by: Nippon Kayaku Co., Ltd.)

The cationic polymerization initiator usable in the present invention is needed to be able to release a substance which can initiate cationic polymerization by light irradiation and/or heating. As the cationic polymerization initiator, for example, there may be mentioned sulfonic ester, imide sulfonate, dialkyl-4-hydroxysulfonium salt, arylsulfonic acid-p-nitrobenzyl ester, silanol-aluminum complexes, (η⁶-benzene)(η⁵-cyclopentadienyl)iron(II). In particular, there may be mentioned benzoin tosylate, 2,5-dinitro benzyl tosylate and N-tosilphthalic imide, for example. The cationic polymerization initiator usable in the present invention is not limited to the above examples, however.

Examples of the polymerization initiator that can be used as both of a radical polymerization initiator and cationic polymerization initiator include aromatic iodonium salts, aromatic sulfonium salts, aromatic diazonium salts, aromatic phosphonium salts, triazine compounds and arene iron complexes. In particular, for example, there may be mentioned iodonium salts including a chloride, bromide, fluoroborate salt, hexafluorophosphate salt and hexafluoroantimonate salt of iodonium, such as diphenyliodonium, ditolyliodonium, bis(p-tert-butylphenyl)iodonium and bis(p-chlorophenyl)iodonium; sulfonium salts including a chloride, bromide, fluoroborate salt, hexafluorophosphate salt and hexafluoroantimonate salt of sulfonium, such as triphenylsulfonium, 4-tert-butyltriphenylsulfonium and tris(4-methylphenyl)sulfonium; and 2,4,6-substituted-1,3,5-triazine compounds such as 2,4,6-tris(trichloromethyl)-1,3,5-triazine, 2-phenyl-4,6-bis(trichloromethyl)-1,3,5-triazine and 2-methyl-4,6-bis(trichloromethyl)-1,3,5-triazine. The polymerization initiator that can be used as both of a radical polymerization initiator and cationic polymerization initiator is not limited to the above examples, however.

### (Anti-Static Agent)

Specific examples of the anti-static agent include various kinds of cationic compounds having a cationic group, such as a quaternary ammonium salt, a pyridinium salt and a primary, secondary or tertiary amino group; anionic compounds having an anionic group such as a sulfonic acid base, a sulfuric ester base, a phosphoric ester base and a phosphoric acid base; amphoteric compounds such as an amino acid-based amphoteric compound and an aminosulfuric ester-based amphoteric compound; nonionic compounds such as an amino alcohol-based nonionic compound, a glycerin-based nonionic compound and a polyethylene glycol-based nonionic compound; organometallic compounds such as alkoxides of tin and titanium; and metal chelate compounds such as acetylacetonate salts of the organometallic compounds. Furthermore, compounds produced by increasing the molecular weight of the above compounds may also be mentioned. In addition, as the anti-static agent, there may be used monomers or oligomers which contain a tertiary amino group, quaternary ammonium group or metallic chelate moiety and are polymerizable upon exposure to ionizing radiation, or polymerizable compounds including organometallic compounds such as a coupling agent having a functional group.

As the anti-static agent, there may be also used electroconductive polymers. No particular limitation is imposed on the electroconductive polymers usable in the present invention, and there may be mentioned, for example, aromatic conjugated poly(paraphenylene), heterocyclic conjugated polypyrrole or polythiophene, aliphatic conjugated polyacetylene, heteroatom-containing conjugated polyaniline, mixed conjugated poly(phenylenevinylene), a multi-chain type conjugated system which is a conjugated system having a plurality of conjugated chain in a molecule thereof, and an electroconductive complex which is a polymer formed by graft- or block-copolymerization of said conjugated polymer chain with a saturated polymer.

Also, electroconductive fine particles are included in the examples of the anti-static agent. Specific examples of the electroconductive fine particles include fine particles of metal oxides. Such metal oxides include, for example, ZnO (refractive index 1.90; hereinafter, each of the numerical values in parentheses means the refractive index), CeO₂ (1.95), Sb₂O₂ (1.71), SnO₂ (1.997), indium tin oxide (often abbreviated as ITO, 1.95), In₂O₃ (2.00), Al₂O₃ (1.63), antimony-doped tin oxide (abbreviated as ATO, 2.0) and aluminum-doped zinc oxide (abbreviated as AZO, 2.0). The average particle diameter of the electroconductive fine particles is preferably from 0.1 nm to 0.1 μm. By setting the average particle diameter in this range, when dispersed in a binder, the electroconductive fine particles give a composition which is able to form a highly transparent layer which causes almost no haze and has excellent total light transmittance.

### (Anti-Glare Agent)

As the anti-glare agent, there may be mentioned fine particles. The shape of the fine particles may be perfect spherical, elliptical or the like, and is preferably perfect spherical. The fine particles may be inorganic or organic fine particles, and are preferably those comprising organic materials. To impart anti-glare properties, the fine particles are preferably optically-transparent. Specific examples of the fine particles include plastic beads, and among them, those having optical transparency are preferred. Specific examples of such plastic beads include styrene beads (refractive index 1.59), melamine beads (refractive index 1.57), acrylic beads (refractive index 1.49), acrylic-styrene beads (refractive index 1.54), polycarbonate beads and polyethylene beads. The added amount of the fine particles is from 2 to 30 parts by weight, preferably from about 10 to about 25 parts by weight, with respect to 100 parts by weight of the resin composition.

### (Leveling Agent)

A leveling agent may be added to the curable resin composition for a hard coat layer of the present invention, which is preferably a fluorine-contained, silicone-contained or other leveling agent. The curable resin composition for a hard coat layer mixed with a leveling agent can impart stable coatability, slidability, anti-fouling properties and abrasion resistance to the surface of a coating film that is formed with the composition, at the time of applying the composition or drying the applied composition.

The added amount of the leveling agent is preferably from 0 to 0.5 wt %, more preferably from 0 to 0.2 wt %, still more preferably from 0.01 to 0.2 wt % with respect to the total solid content of the curable resin composition for a hard coat layer.

The leveling agent may or may not contain ionizing radiation-curable groups.

The leveling agent may be a commercial product. Examples of the commercial products which may be used as the leveling agent are as follows.

Commercially available leveling agents which have no ionizing radiation-curable groups include, for example, the MEGAFACE series such as MCF350-5, F472, F476, F445, F444, F443, F178, F470, F475, F479, F477, F482, F486, TF1025, F478 and F178K (product names; manufactured by: DIC Corporation); X22-3710, X22-162C, X22-3701E, X22160AS, X22170DX, X224015, X22176DX, X22-176F, X224272, KF8001, X22-2000 and so on (product names; manufactured by: Shin-Etsu Chemical Co., Ltd.); FM4421, FM0425, FMDA26, FS1265 and so on (product names; manufactured by: Chisso Corporation); BY16-750, BY16880, BY16848, SF8427, SF8421, SH3746, SH8400, SF3771, SH3749, SH3748, SH8410 and soon (product names; manufactured by: Dow Corning Toray Co., Ltd.); and the TSF series such as TSF4460, TSF4440, TSF4445, TSF4450, TSF4446, TSF4453, TSF4452, TSF4730 and TSF4770, FGF502, the SILWET series such as SILWETL77, SILWETL2780, SILWETL7608, SILWETL7001, SILWETL7002, SILWETL7087, SILWETL7200, SILWETL7210, SILWETL7220, SILWETL7230, SILWETL7500, SILWETL7510, SILWETL7600, SILWETL7602, SILWETL7604, SILWETL7604, SILWETL7605, SILWETL7607, SILWETL7622, SILWETL7644, SILWETL7650, SILWETL7657, SILWETL8500, SILWETL8600, SILWETL8610, SILWETL8620 and SILWETL720 (product names; manufactured by: Momentive Performance Materials Inc.)

Furthermore, there may be mentioned the KB series and the FTERGENT series such as FTX218, 250, 245M, 209F, 222F, 245F, 208G, 218G, 240G, 206D and 240D (product names; manufactured by NEOS Co., Ltd.); BYK333, 300 and so on (product name; manufactured by: BYK-Chemie Japan KK); and KL600 and so on (product name; manufactured by Kyoeisha Chemical Co., Ltd.)

Commercially available leveling agents which have ionizing radiation-curable groups include, for example, X22-163A, X22-173DX, X22-163C, KF101, X22164A, X24-8201, X22174DX, X22164C, X222426, X222445, X222457, X222459, X22245, X221602, X221603, X22164E, X22164B, X22164C, X22164D TM0701 and so on (product names; manufactured by: Shin-Etsu Chemical Co., Ltd.); the Silaplane series such as FM0725, FM0721, FM7725, FM7721, FM7726 and FM7727 (product names; manufactured by: Chisso Corporation); SF8411, SF8413, BY16-152D, BY16-152, BY16-152C, 8388A and so on (product names; manufactured by: Dow Corning Toray Co., Ltd.); SUA1900L10, SUA1900L6 and so on (product names; manufactured by Shin-Nakamura Chemical Co., Ltd.); Ebecry11360, Ebecry1350, KRM7039, KRM7734 and so on (product names; manufactured by: AICEL-CYTEC Co., Ltd.); TEGO Rad2100, 2200N, 2500, 2600, 2700 and so on (product names; manufactured by: Evonik Degussa Japan Co., Ltd.); AF100 (product name; Idemitsu Kosan Co., Ltd.); H512X, H513X, H514X and so on (product names; manufactured by: Mitsubishi Chemical Corporation); OPTOOL DAC (product name; manufactured by: Daikin Industries, Ltd.); UT3971, UT4315 and UT4313 (product names; manufactured by: The Nippon Synthetic Chemical Industry Co., Ltd.); the DEFENSA series such as TF3001, TF3000, TF3004, TF3028, TF3027, TF3026 and TF3025, and the RS series such as RS71, RS101, RS102, RS103, RS104 and RS105 (product names; manufactured by: DIC corporation); BYK3500 (product name; manufactured by: BYK-Chemie Japan KK); LIGHT PROCOAT AFC3000 (product name; manufactured by: Kyoeisha Chemical Co., Ltd.); KNS5300 (product name; manufactured by: Shin-Etsu Chemical Co., Ltd.); UVHC1105 and UVHC8550 (product names; manufactured by: Momentive Performance Materials Inc.); and ACS-1122, the RIPEL COAT series and so on (product names; manufactured by: NIPPON PAINT Co., Ltd.)

### 3. Other Layers

As described above, the optical sheet of the present invention basically comprises a substrate and hard coat layer. However, considering the functions and applications of the optical sheet, one or more layers that will be described below may be provided on the substrate-side surface of the hard coat layer or on the surface on the side opposite to the substrate side of the hard coat layer, without departing from the scope of the present invention.

The thickness of other layers depends on laminating conditions. Accordingly, the thickness may be appropriately adjusted and is preferably a minimum thickness that allows other layers to exhibit their effects, such as a thickness from 10 to 200 nm.

### (Anti-Static Layer)

The anti-static layer comprises a cured product of a curable resin composition for an anti-static layer, which comprising an anti-static agent and a curable resin. This layer may be provided on the substrate side-surface of the hard coat layer or on the surface on the side opposite to the substrate side of the hard coat layer. The thickness of the anti-static layer is preferably from about 30 nm to about 3 μm.

As the anti-static agent, anti-static agents that are the same as those described in connection with the hard coat layer may be used.

As the curable resin contained in the curable resin composition for an anti-static layer, one may be appropriately selected from known curable resins for use solely, or two or more kinds of curable resins may be appropriately selected therefrom for use in combination.

### (Anti-Fouling Layer)

In a preferred embodiment of the present invention, to prevent the outermost surface of the optical sheet from contamination, an anti-fouling layer may be provided on the outermost surface of the optical sheet, which is on the side opposite to the substrate side of the optical sheet. The anti-fouling layer can further improve the anti-fouling properties and abrasion resistance of the optical sheet. The anti-fouling layer comprises a cured product of a curable resin composition for an anti-fouling layer, which comprising an anti-fouling agent and a curable resin.

As the anti-fouling agent contained in the curable resin composition for an anti-fouling layer, one may be appropriately selected from known anti-fouling agents for use solely, or two or more kinds of anti-fouling agents may be appropriately selected therefrom for use in combination. It is the same with the curable resin contained in the curable resin composition.

### (Low Refractive Index Layer)

The low refractive index layer is a layer which has a lower refractive index than that of a layer adjacent to the substrate side of the low refractive index layer. It comprises a cured product of a curable resin composition for a low refractive index layer. A known low refractive index curable resin or known fine particles may be appropriately used in the curable resin composition so that the low refractive index layer is imparted with a lower refractive index than that of said adjacent layer.

### (Second Hard Coat Layer)

From the viewpoint of preventing curling and increasing the hardness of the optical sheet further, a second hard coat layer having a smooth surface may be provided on the substrate side of the hard coat layer.

As the second hard coat layer, one which is the same as the above-mentioned hard coat layer may be used, and these two hard coat layers may be the same with or different from each other in composition.

### II. Method for Producing the Optical Sheet

The method for producing the optical sheet according to the present invention comprises the steps of:

preparing a curable resin composition for a hard coat layer, which composition comprising reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind;

forming a coating by applying the curable resin composition for a hard coat layer onto one surface of a substrate; and

forming a hard coat layer by curing the coating under light irradiation, with or after preventing that the long axes of the reactive, irregularly shaped silica fine particles are each oriented in a direction planar to a virtual plane parallel to the hard coat layer.

In the step of forming a hard coat layer, by curing the coating under light irradiation with or after preventing that the long axes of the reactive, irregularly shaped silica fine particles are each oriented in a direction planar to the virtual plane, the cross-linked, irregularly shaped silica fine particles are allowed to have the three-dimensional configuration easily on an interface on the side opposite to the substrate side of the hard coat layer and in the vicinity of the interface, so that an optical sheet with excellent abrasion resistance and hardness can be easily produced.

In the method for producing the optical sheet according to the present invention, as the curable resin composition for a hard coat layer, the above-mentioned curable resin composition for a hard coat layer may be used.

In general, the curable resin composition for a hard coat layer is prepared by, according to a common preparation method, mixing reactive, irregularly shaped silica fine particles, a binder component, a polymerization initiator, etc., with a solvent and performing a dispersion treatment on the mixture. For the dispersion treatment, a paint shaker, beads mill or the like may be used. If the binder component has fluidity, the curable resin composition for a hard coat layer may be applied on the substrate without using a solvent, so that it is only necessary to use a solvent appropriately as needed.

The coating method is not particularly limited as long as it can uniformly apply the curable resin composition for a hard coat layer onto the surface of the substrate. For example, there may be used various kinds of methods such as a spin coating method, a dipping method, a spraying method, a slide coating method, a bar coating method, a meniscus coating method, a flexo printing method, a screen printing method and a speed coater method.

The amount of the curable resin composition for a hard coat layer applied onto the substrate varies depending on the performance required for the optical sheet to be obtained. It may be appropriately adjusted so that the hard coat layer can have a thickness from 3 to 25 μm when dried, and is preferably at a coverage of 3 g/m² to 30 g/m², particularly preferably 5 g/m² to 25 g/m².

In the step of forming a hard coat layer, as the method for preventing each of the long axes of the reactive, irregularly shaped silica fine particles from being oriented in a direction planar to the virtual plane, it is preferable to control the time that the coating layer reaches a hardness that the reactive, irregularly shaped silica fine particles, which are uniformly dispersed in the curable resin composition for a hard coat layer, are not allowed to rotate. For example, there may be a method for curing the hard coat layer before the long axes of the irregularly shaped silica fine particles are each oriented parallel to the virtual plane by selecting an appropriate solvent, setting the drying temperature, controlling the volatility of the solvent by sending air for volatilizing the solvent, or controlling the temporal intensity distribution of light irradiation for curing. Besides the method, by using a highly viscous binder component such as a polymeric acrylate, the irregularly shaped silica fine particles are prevented from being oriented parallel to the virtual plane in the coating or gathering on the substrate side of the coating, so that it becomes easy for the irregularly shaped silica fine particles to form the three-dimensional configuration.

As the drying method, for example, there may be drying under reduced pressure, drying by heating, or a combination thereof. In the case of drying at normal pressure, drying at a temperature from 30 to 110° C. is preferable. For example, in the case of using methyl isobutyl ketone as the solvent for the curable resin composition for a hard coat layer, the drying step is performed at a temperature in the range normally from room temperature to 80° C., preferably from 40° C. to 70° C., and for a time period from 20 seconds to 3 minutes, preferably from 30 seconds to 1 minute.

Next, the coating formed by applying the curable resin composition for a hard coat layer and drying the same as needed is cured under light irradiation depending on the reactive functional groups of the reactive, irregularly shaped silica fine particles contained in the curable resin composition and those of the binder component contained in the same, thereby forming a hard coat layer comprising the cured product of the curable resin composition for a hard coat layer.

For the light irradiation, in many cases, ultraviolet rays, visible light, electron beam, ionizing radiation or the like is used. In the case of ultraviolet curing, for example, ultraviolet rays emitted from a light source such as a ultra-high-pressure mercury lamp, a high-pressure mercury lamp, a low-pressure mercury lamp, a carbon arc lamp, a xenon arc lamp or a metal halide lamp, are used. The irradiance level of the linear energy beam source is about 50 to 5000 mJ/cm². This is the integral exposure amount of light at an ultraviolet wavelength of 365 nm.

In the case of heating after the light irradiation, the coating is heated normally at a temperature from 40° C. to 120° C. The coating may be left at room temperature (25° C.) for 24 hours or more to promote reaction.

### (Formation of Other Layers)

To form other layers on the substrate, before applying the curable resin composition for a hard coat layer, curable resin compositions for other layers are applied, dried and subjected to light irradiation and/or heating to form other layers. Thereafter, the hard coat layer may be formed by applying the curable resin composition for a hard coat layer thereon, and curing the same under light irradiation with or after preventing that the long axes of the reactive, irregularly shaped silica fine particles are each oriented in a direction planar to the virtual plane.

To form other layers on the hard coat layer, firstly, the hard coat layer is formed by applying the curable resin composition for a hard coat layer and curing the same under light irradiation with or after preventing that the long axes of the reactive, irregularly shaped silica fine particles are each oriented in a direction planar to the virtual plane. Thereafter, other layers may be formed by applying curable resin compositions for other layers on the hard coat layer, drying the same if necessary, and irradiating the same with light.

### EXAMPLES

Hereinafter, the present invention will be explained in detail with reference to examples. The scope of the present invention may not be limited to the following examples, however.

As reactive, irregularly shaped silica fine particles (1), reactive, irregularly shaped silica fine particles comprising silica fine particles having an average primary particle diameter of 20 nm, a MIBK solvent (dispersion medium), and methacrylate groups (reactive functional groups a) were used, wherein the solid content of the reactive, irregularly shaped silica fine particles was 40%; the average number of the silica fine particles connected by inorganic chemical bonding was 3.5; and the length of the long axes of the reactive, irregularly shaped silica fine particles was 60 nm.

As reactive, irregularly shaped silica fine particles (2), reactive, irregularly shaped silica fine particles comprising silica fine particles having an average primary particle diameter of 20 nm, a MIBK solvent (dispersion medium), and methacrylate groups (reactive functional groups a) were used, wherein the solid content of the reactive, irregularly shaped silica fine particles was 40%; the average number of the silica fine particles connected by inorganic chemical bonding was 5; and the length of the long axes of the reactive, irregularly shaped silica fine particles was 90 nm.

As reactive, irregularly shaped silica fine particles (3), reactive, irregularly shaped silica fine particles comprising silica fine particles having an average primary particle diameter of 5 nm, a MIBK solvent (dispersion medium), and methacrylate groups (reactive functional groups a) were used, wherein the solid content of the reactive, irregularly shaped silica fine particles was 40%; the average number of the silica fine particles connected by inorganic chemical bonding was 3; and the length of the long axes of the reactive, irregularly shaped silica fine particles was 15 nm.

As reactive, irregularly shaped silica fine particles (4), reactive, irregularly shaped silica fine particles comprising silica fine particles having an average primary particle diameter of 45 nm, a MIBK solvent (dispersion medium), and methacrylate groups (reactive functional groups a) were used, wherein the solid content of the reactive, irregularly shaped silica fine particles was 40%; the average number of the silica fine particles connected by inorganic chemical bonding was 5; and the length of the long axes of the reactive, irregularly shaped silica fine particles was 180 nm.

As reactive, irregularly shaped silica fine particles (5), reactive, irregularly shaped silica fine particles comprising silica fine particles having an average primary particle diameter of 200 nm, a MIBK solvent (dispersion medium), and methacrylate groups (reactive functional groups a) were used, wherein the solid contend of the reactive, irregularly shaped silica fine particles was 40%; the average number of the silica fine particles connected by inorganic chemical bonding was 5; and the length of the long axes of the reactive, irregularly shaped silica fine particles was 900 nm.

As irregularly shaped silica fine particles (1) having no reactive functional groups, irregularly shaped silica fine particles comprising silica fine particles having an average primary particle diameter of 20 nm and a MIBK solvent (dispersion medium) were used, wherein the solid content of the irregularly shaped silica fine particles was 40%; the average number of the silica fine particles connected by inorganic chemical bonding was 3.5; and the length of the long axes of the irregularly shaped silica fine particles was 60 nm.

As reactive spherical silica fine particles (1), reactive spherical silica fine particles comprising silica fine particles having an average primary particle diameter of 20 nm, a MIBK solvent (dispersion medium), and methacrylate groups (reactive functional groups a) were used, wherein the solid content of the reactive silica spherical fine particles was 40%.

As reactive spherical silica fine particles (2), reactive spherical silica fine particles comprising silica fine particles having an average primary particle diameter of 80 nm, a MIBK solvent (dispersion medium), and methacrylate groups (reactive functional groups a) were used, wherein the solid content of the reactive spherical silica fine particles was 40%.

As spherical silica fine particles (1), spherical silica fine particles comprising spherical silica fine particles having an average primary particle diameter of 200 nm and a MIBK solvent (dispersion medium) were used, wherein the solid content of the spherical silica fine particles was 40%.

As binder component (1), dipentaerythritolhexaacrylate (DPHA) (manufactured by: Nippon Kayaku Co., Ltd.) was used.

As binder component (2), pentaerythritol triacrylate (PETA) (manufactured by: Nippon Kayaku Co., Ltd.) was used.

As binder component (3), BEAMSET DK1 (product name; a MIBK solvent having 30 or more acrylate groups as reactive functional groups b, a weight average molecular weight of 20,000, and a solid content of 75 wt %; manufactured by: Arakawa Chemical Industries, Ltd.) was used.

As a polymerization initiator, Irgacure 184 (product name; manufactured by: Ciba Japan K.K.) was used.

As a leveling agent, MEGAFACE MCF350-5 (product name; manufactured by: DIC Corporation) was used.

As a transparent substrate film, a TAC film (product name: KC4UY; a triacetyl cellulose resin film having a thickness of 40 μm; manufactured by: KONICA MINOLTA OPTO, INC.)

Abbreviations for the components are as follows:

DPHA: Dipentaerythritol hexaacrylate

PETA: Pentaerythritol triacrylate

MIBK: Methyl isobutyl ketone

TAC: Triacetyl cellulose

### (Preparation of Curable Resin Composition for a Hard Coat Layer)

Curable resin compositions 1 to 13 were each prepared by compounding components of the following composition. Table 1 shows the following: the average primary particle diameter of silica fine particles comprising irregularly shaped silica fine particles contained in each curable resin composition; the average connectivity number of the silica fine particles connected (the average number of the silica fine particles per irregularly shaped silica fine particle); the presence or absence of the reactive functional groups a; the ratio of the reactive, irregularly shaped silica fine particles to the total solid content of each curable resin composition; and the type of the binder component.

### (Curable Resin Composition for a Hard Coat Layer 1)

Reactive, irregularly shaped silica fine particles (1): 150 parts by weight (Solid content: 60 parts by weight)

Binder component (1): 40 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 2)

Reactive, irregularly shaped silica fine particles (1): 125 parts by weight (Solid content: 50 parts by weight)

Binder component (1): 50 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 3)

Reactive, irregularly shaped silica fine particles (1):

100 parts by weight (Solid content: 40 parts by weight)

Binder component (1): 60 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 4)

Reactive, irregularly shaped silica fine particles (2):

150 parts by weight (Solid content: 60 parts by weight)

Binder component (1): 40 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 5)

Reactive, irregularly shaped silica fine particles (3): 150 parts by weight (Solid content: 60 parts by weight)

Binder component (1): 40 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 6)

Reactive, irregularly shaped silica fine particles (1):

150 parts by weight (Solid content: 60 parts by weight)

Binder component (2): 40 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 7)

Reactive, irregularly shaped silica fine particles (1): 150 parts by weight (Solid content: 60 parts by weight)

Binder component (1): 20 parts by weight

Binder component (3): 20 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 8)

Reactive, irregularly shaped silica fine particles (4):

150 parts by weight (Solid content: 60 parts by weight)

Binder component (1): 40 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 9)

Reactive, irregularly shaped silica fine particles (1): 25 parts by weight (Solid content: 10 parts by weight)

Binder component (1): 90 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 10)

Irregularly shaped silica fine particles (1): 150 parts by weight (Solid content: 60 parts by weight)

Binder component (1): 40 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 11)

Reactive, irregularly shaped silica fine particles (5): 100 parts by weight (Solid content: 40 parts by weight)

Binder component (1): 60 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 12)

Reactive spherical silica fine particles (1): 25 parts by weight (Solid content: 10 parts by weight)

Binder component (1): 90 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 13)

Reactive spherical silica fine particles (2): 25 parts by weight (Solid content: 10 parts by weight)

Binder component (1): 90 parts by weight

Irgacure 184: 4 parts by weight

MEGAFACE MCF350-5: 0.2 part by weight (Solid content)

MIBK: 54 parts by weight

### (Curable Resin Composition for a Hard Coat Layer 14)

Spherical silica fine particles (1): 150 parts by weight (Solid content: 60 parts by weight)

Binder component (1): 40 parts by weight

Irgacure 184: 4 parts by weight

MEGAFACE MCF350-5: 0.2 part by weight (Solid content)

MIBK: 54 parts by weight

TABLE 1

| | | Fine particles | | | | | |
|---|---|---|---|---|---|---|---|
| | | | Average | | | Ratio of fine particles | |
| | | | primary | Average | Reactive | to the total solid | Type of |
| | Curable resin | | diameter | connectivity | functional | content of composition | binder |
| | composition | Shape | (nm) | number | groups a | (wt %) | component |
| Example 1 | 1 | Irregularly | 20 | 3.5 | Present | 57.6 | DPHA |
| | | shaped | | | | | |
| Example 2 | 2 | Irregularly | 20 | 3.5 | Present | 48.0 | DPHA |
| | | shaped | | | | | |
| Example 3 | 3 | Irregularly | 20 | 3.5 | Present | 38.4 | DPHA |
| | | shaped | | | | | |
| Example 4 | 4 | Irregularly | 20 | 5 | Present | 57.6 | DPHA |
| | | shaped | | | | | |
| Example 5 | 5 | Irregularly | 5 | 3 | Present | 57.6 | DPHA |
| | | shaped | | | | | |
| Example 6 | 6 | Irregularly | 20 | 3.5 | Present | 57.6 | PETA |
| | | shaped | | | | | |
| Example 7 | 7 | Irregularly | 20 | 3.5 | Present | 57.6 | DK1/DPHA |
| | | shaped | | | | | (1/1) |
| Example 8 | 8 | Irregularly | 45 | 5 | Present | 57.6 | DPHA |
| | | shaped | | | | | |
| Example 9 | 1 | Irregularly | 20 | 3.5 | Present | 57.6 | DPHA |
| | | shaped | | | | | |
| Comparative | 9 | Irregularly | 20 | 3.5 | Present | 9.6 | DPHA |
| Example 1 | | shaped | | | | | |
| Comparative | 9 | Irregularly | 20 | 3.5 | Present | 9.6 | DPHA |
| Example 2 | | shaped | | | | | |
| Comparative | 10 | Irregularly | 20 | 3.5 | Absent | 57.6 | DPHA |
| Example 3 | | shaped | | | | | |
| Comparative | 11 | Irregularly | 200 | 5 | Present | 38.4 | DPHA |
| Example 4 | | shaped | | | | | |
| Comparative | 12 | Spherical | 20 | 1 | Present | 9.6 | DPHA |
| Example 5 | | | | | | | |
| Comparative | 13 | Spherical | 80 | 1 | Present | 9.6 | DPHA |
| Example 6 | | | | | | | |
| Comparative | 14 | Spherical | 200 | 1 | Absent | 57.6 | DPHA |
| Example 7 | | | | | | | |

### Example 1

### Preparation of Optical Sheet

On one surface of a TAC film, the curable resin composition for a hard coat layer 1 was applied and dried in a heat oven at a temperature of 70° C. for 60 seconds to vaporize the solvent in the resultant coating. Ultraviolet light was applied thereto so as to reach an integral amount of light of 200 mJ/cm² to cure the coating, thereby forming a hard coat layer having a thickness of 15 μm and a height of protruded portions (convex portions) of 10 nm and thus preparing the optical sheet of Example 1.

### Examples 2 to 9

The optical sheets of Examples 2 to 9 were prepared in the same manner as in Example 1, except that instead of the curable resin composition for a hard coat layer 1, the curable resin compositions shown in Table 1 were used in Examples 2 to 9.

### Comparative Examples 1, 2 and 4

The optical sheets of Comparative Examples 1, 2 and 4 were prepared in the same manner as in Example 1, except that the curable resin compositions shown in Table 1 were used in Comparative Examples 1, 2 and 4 instead of the curable resin composition for a hard coat layer 1, and the coating was dried in a heat oven at a temperature of 40° C. for 180 seconds.

### Comparative Examples 3, 5 to 7

The optical sheets of Comparative Examples 3, 5 to 7 were prepared in the same manner as in Example 1, except that instead of the curable resin composition for a hard coat layer 1, the curable resin compositions shown in Table 1 were used in Comparative Examples 3, 5 to 7.

### (Evaluation of Optical Sheets)

The optical sheets prepared in Examples 1 to 9 and Comparative Examples 1 to 7 were evaluated for the position of the upper and lower ends of the long axes of the irregularly shaped silica fine particles, the number of the irregularly shaped silica fine particles having said three-dimensional configuration per 500 nm of length in a direction planar to the virtual plane, pencil hardness, abrasion resistance and haze.

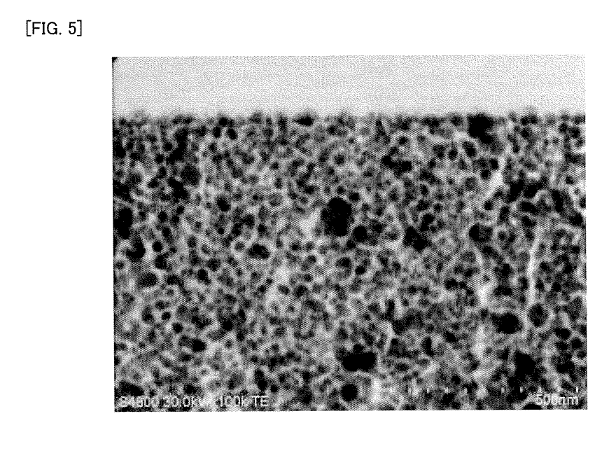

The results are shown in Table 2. The position of the upper and lower ends of the long axes of the irregularly shaped silica fine particles and the number of the irregularly shaped silica fine particles having said three-dimensional configuration per 500 nm of length in a direction planar to the virtual plane, were evaluated by using a SEM photograph. In any of Examples 1 to 9 and Comparative Examples 1 to 7, the position of the upper and lower ends of the long axes of the irregularly shaped silica fine particles was shallower than the depth from the interface on the side opposite to the substrate side of the hard coat layer to half the average primary particle diameter (that is, between said interface and the depth that is half the average primary particle diameter). FIG. 5 shows a SEM photograph of the substrate side of the hard coat layer of the optical sheet obtained in Example 1, which is opposite to the TAC film side of the hard coat layer.

### (Evaluation: Pencil Hardness)

Pencil hardness test (pencil scratch test) defined in JIS K5600-5-4 (1999) was performed on the optical sheets with a load of 4.9 N by means of test pencils defined in JIS-S-6006 to evaluate the highest pencil hardness which causes no scratch, after conditioning the humidity of the optical sheets for two hours under the condition of a temperature of 25° C. and a relative humidity of 60%.

### (Evaluation: Abrasion Resistance)

By means of steel wool #0000, each of the optical sheets was rubbed back and forth 10 times at a speed of 100 mm/sec with a load of 4.9 N/cm². Then, the presence of scratches was visually observed. The evaluation criteria are as follows:

o: No scratches are found

x: Scratches are found

### (Evaluation: Haze)

The optical sheets were measured for the haze value (%) by means of a haze meter (product name: HM-150; manufactured by: Murakami Color Research Laboratory Co., Ltd.) in accordance with JIS K-7136.

o:1.0% or less

x: more than 1.0%

TABLE 2

| | | Depth of the | Number of irregularly shaped | | | |
|---|---|---|---|---|---|---|
| | | position of the | silica particles having | | | |
| | | lower end of | a three-dimensional | | | |
| | Curable resin | the long axes | configuration per | Pencil | Abrasion | |
| | composition | (nm) | 500 nm of length | hardness | resistance | Haze |
| Example 1 | 1 | 60 | 7 | 6H | ∘ | ∘ |
| Example 2 | 2 | 60 | 6 | 6H | ∘ | ∘ |
| Example 3 | 3 | 60 | 3 | 5H | ∘ | ∘ |
| Example 4 | 4 | 60 | 9 | 6H | ∘ | ∘ |
| Example 5 | 5 | 13 | 31 | 6H | ∘ | ∘ |
| Example 6 | 6 | 60 | 7 | 6H | ∘ | ∘ |
| Example 7 | 7 | 60 | 8 | 6H | ∘ | ∘ |
| Example 8 | 8 | 120 | 3 | 6H | ∘ | ∘ |
| Example 9 | 1 | 80 | 7 | 6H | ∘ | ∘ |
| Comparative | 9 | 20 | 0 | 4H | x | ∘ |
| Example 1 | | | | | | |
| Comparative | 9 | 30 | 0 | 4H | x | ∘ |
| Example 2 | | | | | | |
| Comparative | 10 | 60 | 7 | 3H | x | ∘ |
| Example 3 | | | | | | |
| Comparative | 11 | 300 | 0 | 5H | x | x |
| Example 4 | | | | | | |
| Comparative | 12 | — | — | 4H | x | ∘ |
| Example 5 | | | | | | |
| Comparative | 13 | — | — | 4H | x | ∘ |
| Example 6 | | | | | | |
| Comparative | 14 | — | — | 3H | x | x |
| Example 7 | | | | | | |

It is clear from Table 2 that the optical sheets of Examples 1 to 9 are excellent in pencil hardness, abrasion resistance and haze.

However, in the optical sheets of Comparative Examples 1 and 2, in which the position of the lower end of the long axes of the irregularly shaped silica fine particles is as low as 20 nm or 30 nm, the three-dimensional configuration of the irregularly shaped silica fine particles created an insufficient effect, thereby obtaining low pencil hardness and abrasion resistance.

In the optical sheet of Comparative Example 3, which had no functional groups although the irregularly shaped silica fine particles were used, pencil hardness was as low as 3H. In addition, because of having no functional groups, insufficient cross-linking was obtained. Therefore, many of the irregularly shaped silica fine particles were detached, and the evaluation result on abrasion resistance was poor.

In the optical sheet of Comparative Example 4, in which the average primary particle diameter of the silica fine particles comprising the irregularly shaped silica fine particles was large, the evaluation result on pencil hardness was as good as 5H. However, because of the large average primary particle diameter, the optical transparency was low, thereby obtaining a poor evaluation on haze.

In Comparative Examples 5 and 6 using the reactive spherical silica fine particles and also in Comparative Example 7 using the spherical silica fine particles having no functional groups, no effect was created by the three-dimensional configuration of the irregularly shaped silica fine particles, thereby obtaining a poor evaluation on pencil hardness and abrasion resistance.

What is claimed is:

1. An optical sheet in which a hard coat layer is adjacently provided on one surface of a substrate,
wherein the hard coat layer comprises a cured product of a curable resin composition for a hard coat layer, which composition comprising reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind;
wherein at least part of the reactive, irregularly shaped silica fine particles contained in the hard coat layer are cross-linked to the binder component; and
wherein at least part of the cross-linked, irregularly shaped silica fine particles present on an interface on the side opposite to the substrate side of the hard coat layer and in the vicinity of the interface, have a three-dimensional configuration in the hard coat layer, in which the long axes of the cross-linked, irregularly shaped silica fine particles are each oriented in a direction oblique or perpendicular to a virtual plane parallel to the hard coat layer, one end of each of which axes is present between said interface of the hard coat layer and the depth that is half the average primary particle diameter of the substantially spherical silica fine particles comprising the irregularly shaped silica fine particles, and the other end of each of which axes is present at the depth that is twice or more the average primary particle diameter of the substantially spherical silica fine particles comprising the irregularly shaped silica fine particles.

2. The optical sheet according to claim 1, wherein the number of the irregularly shaped silica fine particles having said three-dimensional configuration and present in the interface on the side opposite to the substrate side of the hard coat layer is three or more per 500 nm of length in a planar direction to the virtual plane.

3. The optical sheet according to claim 1, wherein the substrate is an optically-transparent resin substrate.

4. The optical sheet according to claim 1, wherein the content rate of the reactive, irregularly shaped silica fine particles is from 15 to 70 wt % with respect to the total solid content of the curable resin composition for a hard coat layer.

5. The optical sheet according to claim 1, wherein the hardness of the sheet obtained by the pencil hardness test defined in JIS K5600-5-4 (1999) with a load of 4.9 N is 5H or more.

6. A method for producing an optical sheet, comprising the steps of:
preparing a curable resin composition for a hard coat layer, which composition comprising reactive, irregularly shaped silica fine particles having reactive functional groups a on the surface thereof and a binder component having reactive functional groups b, each of which particles comprises 3 to 20 substantially spherical silica fine particles having an average primary particle diameter from 1 to 100 nm and being connected to each other by inorganic chemical bonding, and each of which functional groups a and b has cross-linking reactivity with a reactive functional group of the same or different kind;
forming a coating by applying the curable resin composition for a hard coat layer onto one surface of a substrate; and
forming a hard coat layer by curing the coating under light irradiation, with or after preventing that the long axes of the reactive, irregularly shaped silica fine particles are each oriented in a direction planar to a virtual plane parallel to the hard coat layer.
